(19) United States
(12) Patent Application Publication
(10) Pub. No.: US 2024/0104585 A1
(43) Pub. Date: Mar. 28, 2024

(54) SYSTEMS AND METHODS FOR DYNAMIC FORMATION OF ANONYMOUS MARKET FOR OVER-THE-COUNTER TRADING

(71) Applicant: OM e-Trading LLC, Litchfield, CT (US)

(72) Inventor: Vinayek K. Singh, Litchfield, CT (US)

(73) Assignee: OM e-Trading LLC, Litchfield, CT (US)

(21) Appl. No.: 18/266,458

(22) PCT Filed: Dec. 9, 2021
(86) PCT No.: PCT/US2021/062545

§ 371 Date: Jun. 9, 2023

Related U.S. Application Data
(60) Provisional application No. 63/123,941, filed on Dec. 10, 2020.

(51) Int. Cl. G06Q 30/0201

(52) U.S. Cl. CPC G06Q 30/0201

(57) ABSTRACT

Described herein are illustrative embodiments of a computer-implemented system realizing a specific approach to over-the-counter (OTC) trading of financial instruments, which may use an anonymous data collection protocol, multiple discrete phases of trading activity with computerized controls over what parties are permitted to participate in each phase, and/or computerized timers to govern transitions between such phases to overcome or mitigate long-standing disadvantages of conventional oral trading techniques. In contrast to conventional OTC approaches that involve manual, verbal discussions of trades only between pairs of parties, some embodiments described herein include a computer-implemented system for exchanging information regarding potential OTC trades of a financial instrument so as to dynamically form a temporary market between multiple parties for OTC trade of the financial instrument. Following trading and/or expiration of a timer, the temporary market is terminated, preventing further trading in the temporary market.

### CROSS-REFERENCE TO RELATED APPLICATIONS

The present application claims the benefit under 35 U.S.C. § 119(e) of U.S. Provisional Patent Application Ser. No. 63/123,941, titled “Systems and Methods for Dynamic Formation of Anonymous Market for Trading of Over-the-Counter Security” and filed on Dec. 10, 2020, the entire contents of which are incorporated herein by reference.

### FIELD

Described herein are illustrative embodiments of a computer-implemented system realizing a specific approach to over-the-counter (OTC) trading of financial instruments, which may use an anonymous data collection protocol, multiple discrete phases of trading activity with computerized controls over what parties are permitted to participate in each phase, and/or computerized timers to govern transitions between such phases to overcome or mitigate long-standing disadvantages of conventional oral trading techniques.

### BACKGROUND

Trading in financial markets and of financial instruments typically takes one of two forms: exchange trading and non-exchange trading.

Exchange trading occurs with the assistance of a public exchange, in which buyers and sellers openly advertise availability of trades and the prices at which the trades may be made. Because of the public nature of exchanges, trades of the same financial instruments (e.g., the same stock for the same company) that occur at the same time typically occur for the same price or roughly the same price. Stock exchanges like the New York Stock Exchange (NYSE), in which stocks are traded publicly and are available at a publicly-advertised price, are an example of exchange.

Non-exchange trades, on the other hand, are not public and are not advertised, but instead occur privately between two parties. Non-exchange trades are also commonly known as over-the-counter (OTC) trades. In an OTC trade, one party may privately offer a trade to another party and the trade may be executed when the other party accepts, and in many cases no one else is notified of the trade, the financial instrument being traded, or the price. The private nature of the trades may lead to trades for the same financial instrument at the same time being carried out at different prices when different pairs of parties are involved. In some cases, one seller may offer the same financial instrument to different buyers at different prices at the same time, because the privacy of the trading decreases the risk that the buyers will discover the different pricing. Similarly, buyers may receive offers for trades of the same financial instrument at the same time from different sellers with different prices.

Different products are traded in the two types of trading. Trades on an exchange may be of standardized instruments, such as securities pre-approved and listed for trade on the exchange, which may be stock in a company. OTC trading may be of other financial instruments that any two parties may wish to exchange, such as securities, commodities, foreign exchange, derivatives, and custom instruments, where the custom instruments may be unique to the two parties trading, not widely traded, held by only a small number of parties, or not standardized.

In conventional trading systems, OTC instruments are segmented into two segregated markets. These segregated markets are commonly referred to as Dealer-to-Dealer (D2D) and Dealer-to-Customer (D2C). A dealer may be a large global bank or an investment bank. The D2D OTC markets are generally facilitated by interdealer brokers (IDBs), which are humans who communicate between dealers to enable trades between the dealers. In the D2C OTC markets, the customers with which the dealers trade may come from a wide array of institutional firms including corporations, insurance companies, asset managers, pension funds, regional banks, and hedge funds. These customers communicate with a dealer's salespeople (e.g., traders), who facilitate any customer inquiry or solicitation regarding the trading of OTC financial instruments. Dealers usually communicate with customers using telephone.

### SUMMARY

In some embodiments, there is provided a method of forming a dynamic, anonymous market for over-the-counter (OTC) trade of a financial instrument. The method comprises operating at least one server of an electronic communication network (ECN) to carry out a series of acts. The series of acts comprises receiving at least one first communication, from a first user of a plurality of users, comprising a description of the financial instrument the first user is seeking to trade, and forming a market for trade of the financial instrument. Forming the market comprises identifying a plurality of second users, from among the plurality of users, to solicit for trading interest in the financial instrument. Identifying the plurality of second users comprises evaluating at least one data store of indications of interest provided by users of the plurality of users to determine whether the financial instrument is one for which an indication of interest indicates a user wants to be solicited. The indications of interest for a user indicate financial instruments and/or types of financial instruments in which the user has indicated interest in being solicited. The forming of the market further comprises outputting to the plurality of second users via the ECN electronic communications soliciting the plurality of second users to provide market level information for a potential trade of the financial instrument. The market level information comprises a bid price and an offer price for the financial instrument. The electronic communications soliciting the plurality of second users comprise information identifying the financial instrument to the plurality of second users and not identifying the first user to the plurality of second users. Forming the market further comprises generating order book information from the market level information received from participating users of the plurality of second users solicited in the soliciting, the order information comprising both bid and offer prices for trade in the financial instrument, and prompting the first user to make a trade in the financial instrument with one or more of the participating users at a price indicated by the order book information generated from the market level information received from the participating users. Forming the market further comprises, following selection of the trade by the first user and/or expiration of a first timer controlling a phase transition of the market, electronically distributing the order book information for the financial instrument to a plurality of third users, of the plurality of users, and prompting the plurality of third users for further trades in the financial instrument. The series of acts further comprises, following expiration of a second timer, terminating the market for trade of the financial instrument. Terminating the market comprises configuring the at least one server not to communicate messages relating to trade in the market following termination.

In some such embodiments, forming, with the at least one server of the ECN, the market for trade of the financial instrument further may comprise setting a length of the first timer controlling the phase transition of the market and/or the second timer relating to termination of the market. Setting the length of the first and/or second timers may comprise setting the length of the first and/or second timers based at least in part on one or more characteristics of the financial instrument.

In some such embodiments, generating the order book information from the market level information received from participating users of the plurality of second users solicited in the soliciting comprises generating the order book information in response to determining that at least a threshold number of quotes have been received from the participating users.

In some such embodiments, forming, with the at least one server of the ECN, the market for trade of the financial instrument further comprises executing trades between users of the plurality of third users following the prompting the plurality of third users for further trades. The trades between the users of the plurality of third users do not include trades involving the first user.

In some such embodiments, executing trades between users of the plurality of third users with the at least one server of the ECN comprises determining, from the order book information, at least one matched pair of quotes indicated in the order book, each matched pair of the at least one matched pair corresponding to a pair of users of the plurality of third users, and executing a trade for each matched pair of quotes of the at least one matched pair of quotes without, following the determining of the matched pair, prompting a corresponding pair of users for the matched pair for whether the corresponding pair of users desires the trade.

In some such embodiments, outputting to the plurality of second users via the ECN the electronic communications soliciting the plurality of second users to provide market level information for a potential trade of the financial instrument comprises outputting the electronic communications soliciting the plurality of second users to provide market level information for a potential trade of at least a set amount of the financial instrument.

In some such embodiments, forming, with the at least one server of the ECN, the market for trade of the financial instrument further comprises, in response to determining that pair of trading users is to perform a trade of the financial instrument, where the pair of trading users including the first user or two users of the plurality of third users, performing a series of acts. The series of acts comprises determining a first desired trading amount for a first trading user of the pair of trading users, determining a second desired trading amount for a second trading user of the pair of trading users, determining a lesser amount of the first desired trading amount and the second desired trading amount, and informing the pair of trading users that the trade will be executed for the lesser amount without informing the first trading user of the second desired trading amount and without informing the second trading user of the first desired trading amount.

In some such embodiments, operating the at least one server of the ECN to carry out the series of acts further comprises receiving registration information for each user of the plurality of users, the registration information comprising for each user the indications of interest indicating the financial instruments and/or types of financial instruments in which the user is interested in being solicited to trade. Receiving the indications of interest comprises receiving one or more indication attributes and/or desired indication values of indication attributes for the financial instruments and/or the types of financial instruments in which the user is interested in being solicited to trade. Receiving from the first user the at least one first communication comprising the description of the financial instrument the first user is seeking to trade comprises receiving one or more instrument attributes and/or one or more instrument attribute values for the financial instrument. Evaluating the indications of interest provided by users of the plurality of users to determine whether the financial instrument is one for which an indication of interest indicates a user wants to be solicited comprises comparing, for each user of the plurality of users, the one or more instrument attributes and/or one or more instrument attribute values to the one or more indication attributes and/or desired indication values of indication attributes.

In some such embodiments, receiving from the first user the at least one first communication comprising the description of the financial instrument the first user is seeking to trade comprises receiving an indication of whether the first user would like to buy or sell the financial instrument, and the electronic communications soliciting the plurality of second users to provide both the bid price and the offer price for the financial instrument do not indicate that the first user has indicated a desire to buy or to sell.

Some embodiments may include any one or any combination of the acts or functionalities described in any one or any combination of the foregoing embodiments.

In some other embodiments, there is provided at least one computer-readable storage medium having encoded thereon executable instructions that, when executed by at least one processor, cause the at least one processor to carry out a method. Such a method may include any one or any combination of the acts or functionalities described in the foregoing embodiments, including any of the methods described in any one or any combination of the foregoing embodiments.

In some further embodiments, there is provided at least one server of an electronic communication network (ECN), the at least one server comprising at least one processor and at least one computer-readable storage medium having encoded thereon executable instructions that, when executed by the at least one processor, cause the at least one processor to carry out a method. Such a method may include any one or any combination of the acts or functionalities described in the foregoing embodiments, including any of the methods described in any one or any combination of the foregoing embodiments.

The foregoing is a non-limiting summary of the invention, which is defined by the attached claims.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart of an exemplary method for starting a dynamic market for a specific OTC financial instrument(s), which may be implemented in some embodiments;

FIG. 2 is a flowchart of an exemplary method for communicating with one or more LP(s) regarding a specific OTC financial instrument in a dynamic market, which may be implemented in some embodiments;

FIG. 3 is a flowchart of an exemplary method for evaluating LP responses to solicitation and identifying a BBO in a first phase of a dynamic market, which may be implemented in some embodiments;

FIG. 4 is a flowchart of an exemplary method for interacting with an LR regarding potential trade of a specific OTC financial instrument in a dynamic market, which may be implemented in some embodiments;

FIG. 5 is a flowchart of an exemplary method for a two-phase dynamic market, which may be implemented in some embodiments;

FIG. 6 is a table illustrating some of the timers that may be included in some embodiments;

FIG. 7 illustrates three flowcharts of system processes that may be included in some embodiments;

FIGS. 8A-8C illustrate elements of a computer system with which some embodiments may operate; and

FIG. 9 is a block diagram of an illustrative computing device with which some embodiments may operate.

### DETAILED DESCRIPTION

Described herein are illustrative embodiments of a computer-implemented system that enables a new model for over-the-counter (OTC) trading of financial instruments. In contrast to conventional OTC approaches that involve manual, verbal discussions of trades only between pairs of parties, some embodiments described herein include a computer-implemented system for exchanging information regarding potential OTC trades of a financial instrument so as to dynamically form a temporary market between multiple parties for OTC trade of the financial instrument. Unlike conventional approaches, the computer-implemented system is able to operate a market with distinct phases, one in which market level information for both sides of a market for the instrument is electronically collected and presented to an initiating party, and a second phase in which that market level information is distributed to enable potential trading by other participants. Moreover, following trading and/or expiration of a timer, the computer-implemented system acts to terminate the temporary market, ending further trading in the temporary market, after which the system does not exchange communications between parties relating to the market or potential trades.

In some such embodiments, the computer-implemented system may receive from an initiating party a description of a financial instrument to be traded in an OTC trade. Based on information regarding the instrument, the system may use a data store of information regarding previously-registered trading interests of users, to identify from among a set of other users of the computer-implemented system other potentially-interested parties who may want to trade and join a dynamically-formed temporary market for trading in the instrument. The system may then solicit the identified parties to provide market level information for the financial instrument to be traded and then compile market level information from responding parties. In an OTC market, the financial instruments being traded may be customizable and non-standardized, and the price of trades may vary between pairs of parties. Given that OTC trading has been done with direct, real-time verbal discussions between parties or representatives, identity of the party/parties has long impacted OTC trading. In some embodiments described herein, the soliciting and collection of market level information may be done by the computer-implemented system using a computer messaging protocol that supports distribution of anonymous market information, making sure the parties are unaware of each other's identities as they exchange the market level information regarding the described instrument. In addition, in some embodiments, regardless of the type of trade (buy or sell) the initiating party may be seeking for the financial instrument, the solicited and provided market level information from parties may include, for each party, both a price at which the party is willing to buy the described instrument and a price at which the party is willing to sell the described instrument. Collection of information for both sides of a potential trade, even when an initiating party is seeking only one type of trade, and in particular collection of such information anonymously (in those embodiments which include anonymous messaging), may provide specific advantages in enabling or facilitating the dynamic formation of a temporary market for trade of the financial instrument in embodiments in which, unlike conventional oral trading techniques, a second phase of open trading may begin following an initial phase of trading for the initiating party.

In some such embodiments, once the initiating party is presented with collected market level information from responding parties, a timer governs options and activities of the initiating party. Conventionally, only the initiating party would possess the information on the potential trades from potential counterparties. The initiating party was the only party in a position to use the information and not under any obligation to use the information and perform a trade. In some embodiments described herein, however, following expiration of a timer, the initiating party's controlling position ends and the computer-implemented system publishes or otherwise distributes the collected market level information to multiple parties (e.g., the responding parties and/or others) that the system identified from the data store of previously-registered interest information as potentially interested in trading in the instrument, to allow for continued trading of the described instrument between multiple interested pairs of parties that are not the initiating party. By electronically and anonymously collecting information on both sides of a potential trade from each party, and then publishing or otherwise distributing the buy and sell levels of multiple parties, multiple potential pairs of trading parties may identify one another and conduct trades using the collected information. This provides distinct advantages over present systems for OTC trading. Following trading or expiration of another timer, the computer-implemented system may then terminate the market, to prevent parties from further communicating with one another via the system for trade in the instrument at the prices indicated in the collected market level information.

Accordingly, described herein are various embodiments of a “Market on Demand” (MOD) system that addresses conventional challenges to trading institutional wholesale OTC instruments, which seamlessly integrates both the inter-dealer and institutional customer trading activities via the use of an electronic communication network (ECN) platform using a specialized communication protocol having features and advantages discussed below. The techniques described herein include a platform and an automated process for determining, aggregating, and growing liquidity and enabling orderly trading of OTC financial instruments, including instruments actively used by institutional firms. Among other advantages discussed herein, such computerized techniques may offer increased efficiency over conventional techniques that rely on oral communication, which may include more access to liquidity, greater anonymity, and automated trade processing.

Some examples described below use terminology that, unless described otherwise in connection with a particular example, may be understood as follows:
Dealer: is an entity, often a bank, with the ability to provide trading liquidity for OTC financial instruments by buying or selling instruments.
Customer: is an entity, which is often not a bank, that buys or sells instruments and may use OTC financial instruments for a variety of reasons including risk management, hedging, asset/liability management and proprietary trading.
Bid: an order to buy an OTC financial instrument for a specified amount.
Offer: an order to sell an OTC financial instrument for a specified amount.
Best Bid/Offer [BBO]: a display of levels of the most aggressive buying and selling interest prioritized by time.
CLOB: Central Limit Order Book (GLOB) is a technique for matching bids and offers according to price and time priority.
Request for Markets [RFM]: A request sent by a market participant asking a market maker to respond with both a bid and an offer quote for a financial instrument.
Market Maker: a person or entity who has the ability and authority to provide both a tradable bid and offer order upon request.
Minimum Trading Amount: The minimum amount to support the quotes provided by the LPs in the initial solicitation process and is also the amount supporting each order in the CLOB.
Liquidity Requestor [LR]: An entity, which may be either a dealer or customer, who is seeking a trade with another party participant, and who in some embodiments described herein initiates a process for forming a market for a financial instrument.
Liquidity Provider [LP]: An entity with the ability to quote a two-sided market for trading an OTC financial instrument or transaction for at least the requested minimum trading amount, and which can serve as a counterparty for a trade for the LR.

OTC trading, despite representing a massive amount of daily trading activity for decades (including trillions of dollars in 2021), suffers from well-known, long-standing inefficiencies and disadvantages that substantially hamper trading. Difficulty of accessing liquidity is one. For standardized instruments that are traded on an exchange, a willing trader (buyer or seller) can often quickly and easily find one or more willing counterparties (sellers or buyers) with relative ease, and the trader is aware of the prevailing price of the standardized instrument (i.e., the prices of recent trades on the exchange) in advance. This makes the standardized instrument relatively “liquid,” in that it can be traded with relative ease and speed. In contrast, non-standardized instruments or instruments that are otherwise traded OTC may be and often are much less liquid. Due to the private nature of the sales, a willing trader may be unaware of any other parties who have traded in a specific instrument recently, or who may want to trade, or at what price. Finding potential counterparties may require directly asking parties if they would like to trade in a particular instrument and may require directly asking a large number of parties before finding even one willing to make a trade in that instrument, and maybe more before finding a potential trade the inquiring trader would consider “good.” Moreover, if the trader approaches potential counterparties, the counterparties may quote prices based on the identity of the trader and that may differ from prices quoted to other parties (which are unknown), making the trader uncertain of whether he or she is getting a “good” deal. Not knowing who potential counterparties are or how to find them, and not knowing what price a trade may get, makes trading difficult and makes these instruments much less liquid.

OTC trading has long required and still requires significant manual, human intervention by “voice brokers” or salespersons who work for dealers. Trading is done largely by oral conversation, often by telephone, between two humans. This slow manual process introduces practical limits on the number of inquiries that may be made and, in turn, the number of trades that may be performed, which limits liquidity for OTC trading. It also introduces informal limitations on access to liquidity due to informal limitations on who the human traders are willing to or feel able to contact (e.g., people they know, people they feel comfortable asking, people they have a telephone number for, people they've worked with before, people they have not had a prior bad experience with, etc.).

Artificial segregation of the OTC market into dealer-to-dealer (D2D) and dealer-to-customer (D2C) further limits liquidity, as there are different humans facilitating the two different OTC markets (human voice brokers primarily facilitate D2D trading and high-touch human salespersons assist in D2C trade execution), and those two different OTC markets include different potential traders (customers are only in the D2C markets, whereas dealers that want to trade with other dealers are in the D2D markets). A financial instrument may be able to be traded in either market and potentially at a different trading level simultaneously. On top of the human factors noted in the preceding paragraph, this market segregation results in further inefficiencies and limits access to liquidity by splitting the potential market: Some traders act only in D2D markets and others work only in D2C markets, while there may be opportunities for people in one market to trade in the others.

Liquidity limitations also arise from the human discussions and from the private nature of OTC trading. When a party wants to buy a financial instrument (or sell an instrument), a human broker or salesperson for the party will speak with counterparties and privately collect the information needed to complete the specific type of desired sale for the party: a sale price (or buy price) for each such counterparty. The human who orally collects the sale prices (or buy prices) from the counterparties will then keep that information private for themselves and their client, even if only one trade is performed with one counterparty. The unselected counterparties (who may be interested in making a buy or sell trade, regardless of the type of trade sought by the first party) do not know of the existence of the others and are not able to trade with the others. This limits the liquidity available to the whole market. Live conversations between traders also means there is no anonymity in the trading, leading to potential for unfairness in price quoting between parties, and live conversations. Lastly, manual performance of trades introduces clear potential for conflicts of interest and human error.

Each of these disadvantages and more have long prevented OTC markets from functioning in a fair and orderly manner and prevented efficient access to liquidity and capital for parties trading in OTC markets.

These and other disadvantages have persisted even as sweeping changes have been made to try to overhaul OTC markets. Since the financial crisis in 2007/2008 and the adoption of the regulatory changes required by the Dodd-Frank Act, either the CFTC or SEC now regulate the OTC financial markets. In addition to regulatory changes, the OTC markets have undergone some other significant changes. These changes include the requirement that trading activities must be facilitated on a Swap Execution Facility (SEF), eligible OTC transactions need to be settled and cleared at a central clearinghouse followed by timely post-trade reporting of all trades to a registered Swap Data Repository (SDR). SEFs are one attempt by regulators for improving rules for trading, increasing transparency and participation, and encouraging electronically-implemented OTC trading systems. Conventional SEFs attempt to merely mirror pre-financial crisis trading models using a computer. These include broker assisted software (Hybrid Model) that replicates the traditional Inter-Dealer Broker (IDB) methods for direct communication with a limited number of dealers using the phone or messaging tools for the segregated Dealer-to-Dealer (D2D) market participants. The human broker still provides the same service as before regulatory reform, by directly communicating with dealers to trade bilaterally amongst themselves and using the electronic SEF to register the trade for post-trade processing and reporting. The Dealer-to-Customer (D2C) SEFs have simply automated the need for a client to access a few quotes from a small group of dealers that they have traditionally maintained a trading or banking relationship with. For example, a D2C SEF may be able to distribute a communication asking for quotes on behalf of a customer, but because it leverages the same model from prior to regulatory reforms, the SEF would disclose the identity, trading quantity and direction (buyer or seller) of the customer and ask only for one side of a market (e.g., if the requestor wanted to sell, dealers would be asked to quote a buy price for that specific customer and quantity). Because both D2D and D2C SEFs leverage their pre-financial crisis business models, they have not been able to overcome usability and implementation challenges mentioned above: lack of anonymity, limited contacts and thus limited liquidity, segregated markets with division into D2D and D2C, and so on. Due to these challenges, even where traders are required to execute trades via a SEF or enter the trade details into a SEF, traders often identify and negotiate such trades outside of the SEF and then merely input the trade details into the SEF for record-keeping. Accordingly, despite major regulatory reforms, the basic market structure for trading most OTC instruments has not changed significantly from the period prior to the financial crisis, the well-known disadvantages discussed above have persisted, and OTC markets have not been able to be reliably performed with a computer-implemented trading system.

Variation in tradeable instruments, variation in party identities, variation in price, variation in quantity, variation in non-price parameters of trades such as clearing and settlement, and variation in other attributes, as well as artificial segregation of the market and the key role human factors have played in negotiating trades complicate OTC trading, and have for as long as there have been OTC markets. Another complicating factor that has undermined a reliable computerized implementation has been that OTC markets, particularly for non-standard instruments, are fundamentally discontinuous. This means there is not liquidity for trading activity at all times; in fact, there may be relatively long periods where there are no trades for a particular instrument or type of instrument. In addition, most OTC instruments are used by institutional firms and banks for large or block size trading with a preference for the transference of risk with as little price disruption as possible, which has been traditionally managed by brokers or salesperson(s). This contrasts with highly regulated exchange-listed and cleared standardized instruments (such as equities and commodities) that are highly automated, accessible to all participants, are denominated in small trading increments to allow retail to participate and offer the perception of continuous trading liquidity with the aid of specialist (market-making) firms. Due to factors mentioned above the trading of OTC instruments, despite attempts, has never been able to be reliably implemented in a computerized trading system.

The inventor has therefore recognized and appreciated that there are well-known and long-standing challenges and disadvantages to OTC trading, which are so fundamental they persist even while there are major regulatory and other changes made to OTC markets. These challenges/disadvantages and other fundamental attributes of OTC markets have frustrated and prevented successful computerized approaches to OTC trading in the past, leaving these multi-trillion-dollar markets even in 2021 implemented as slow, error-prone human-based trades that mostly occur by phone.

The inventor has also recognized and appreciated that while there would be clear advantages to being able to implement OTC trading in a computer platform, computer implementation alone would not be enough to address the difficulties inherent in the OTC markets. Even if a conventional trading approach for OTC markets were to be reliably computerized (which has not been possible to date, as the industry's experience with SEFs has shown), the inventor has recognized that the OTC market would still suffer from challenges in liquidity, efficiency, and fairness. This is because a computer implementation of the current approach would still suffer from difficulties in finding potential counterparties, limited availability of information, and the problems introduced by the lack of anonymity.

As such, the inventor has recognized and appreciated that there would be advantages to a computerized approach that includes technologies to overhaul the longstanding manner in which OTC trading has been conducted, by introducing a different sequence of interactions, different communications between parties, and new features enabled by the computer implementation that would provide greater liquidity in the market, more efficient trading, and more fair trading.

Described herein are therefore computer platform with technical elements that, when implemented with OTC trading, provide for electronic communication of different types of requests for information and of different types of information than are exchanged in traditional oral conversations for OTC trading, and that include computer-implemented features that have no analogue in traditional manual/verbal OTC trading and that could not be implemented in a manual/verbal context without a computer platform.

Some embodiments of a Market on Demand (MOD) platform described herein enable facilitation of certain types of electronic trading between institutional wholesale financial market participants, using a computer platform and a communication protocol. MOD is a system for trading simple and complex over-the-counter (OTC) financial instruments, including securities, commodities, derivatives, and other instruments. The MOD protocol and system described herein include a platform and an automated process for creating liquidity and orderly block size trading of OTC financial instruments, including instruments actively used by institutional firms globally. Processes described herein may offer increased efficiency over conventional techniques, which may include more access to liquidity, greater anonymity, and/or automated trade processing.

More specifically, in some embodiments, the MOD platform makes dynamically available on-demand markets for trading Over-the-Counter (OTC) financial instruments, where such markets exist temporarily following dynamic formation and are subsequently terminated. “Dynamic” markets include markets in which multiple parties participate and may be willing to trade in a financial instrument and that form in response to an inquiry from a trader regarding potential trades in the financial instrument. As should be appreciated from the foregoing, unlike exchange-based trading, there may not be an open, existing market for an OTC financial instrument at a given time that a trader would like to perform a trade. The MOD system may facilitate a dynamic market formation for an OTC financial instrument in which market participants solicit and provide bids and offers for an OTC financial instrument on which the market is based. In some embodiments, the MOD platform may allow for such a platform to maintain anonymity of traders on the solicitation or provision side until market participants agree to trade. Following the trading enabled by this dynamic market formation, the market that was created for that OTC financial instrument ends. Multiple markets may be formed and end in parallel, each for an OTC financial instrument, and when a market ends for an OTC financial instrument at one time, a market may be subsequently created for that OTC financial instrument at a future time in response to a trader soliciting bids/offers for the instrument.

In contrast to conventional OTC market approaches in which only an initiating party holds the information regarding trading interest and prices for potential counterparties and thus has the only option to trade or not, in some embodiments, once an initial trade is performed for a financial instrument or once a timer has expired, a MOD platform as described herein may enable a second phase of the dynamically-created temporary market to be performed. This two-phase approach has no analogue outside of this computerized setting. In this new, second phase, the market level information that was initially private to the initiating party is distributed to other parties to enable those other parties to perform subsequent trades in the dynamically-created market with one another without involving the initiating party, for a temporary period during which the temporary market still exists. These trades may be completed using bids/offers that were initially solicited and provided to the system and to the initiating party but were not select for trade by the initiating party. The temporary market is still based on the same financial instrument that the initiating party described and for which the market was formed, so this temporary market is usable only for exchange of electronic communications regarding trade of that financial instrument. And, in some embodiments, the system may impose constraints (e.g., by regulating exchange of communications) on who may trade during the second phase and/or on an order or priority in which parties may trade, such as based on whether the party provided market level information in response to the solicitation and/or what levels were specified in the market level information. Such a second phase of a dynamic market may enable more traders to complete more desired trades without needing to start over in a market, by using already solicited and provided bid/offer prices. The restrictions of segregated markets and broker-facilitated direct conversations between limited potential parties meant conventional markets have long left some potential trades unfulfilled once the initiating party's trading has been completed, frustrating the trading activities of other traders. Techniques described herein for offering a second round of trading can instead fulfill those previously-unfulfilled trades. Such previously-unfulfilled trades may include trades between counterparties not including the participant who originally created the dynamic market with the original solicitation, as in some embodiments once the initial trade has been completed, the solicited bids/offers may be made visible to other parties than just the original solicitor.

This second phase of trading may be enabled or facilitated by features included in some embodiments but that do not feature in conventional OTC trading approaches, and that are enabled by a computer implementation.

First, the computer-implemented system leverages a data store of previously-registered interest information for users, indicating the financial instruments or types of financial instrument each user is interested in trading and thus that the user is willing to receive solicitations regarding. The system leverages this data store to identify, based on a description of a financial instrument submitted by an initiating party, a set of users to solicit for information regarding potential trades. These users may be identified from a set of all registered users of the system, which may include users that are associated with “customers” in traditional D2C markets as well as with “dealers” in traditional D2D markets, thus avoiding artificial segregation present in conventional approaches. Human factors have led to maintaining that artificial segregation of markets in the past: voice brokers wanted to keep their contacts in their D2D markets and felt comfortable speaking with their contacts in their contexts, whereas salespeople for D2C markets felt the same way. Computer platforms described herein automate the solicitation process by collecting from all users (e.g., both customers and dealers) their indications of interest, then leveraging those indications of interest to determine, for each new dynamic market that is created, whether a particular user has indicated that the user would like to be solicited for trade in the dynamic instrument of that dynamic market.

Second, once the users are identified, the computer-implemented system builds a data store of market level information from multiple parties for the temporary market, indicating both buy and sell prices for the financial instrument of the temporary market from each responding party. The computer-implemented system builds this data store by soliciting market level information from each identified potential trading parties for both sides of a market (both a buy side and a sell side) for the financial instrument. This is the even when the initiating party may have indicated interest in only one type of trade (i.e., buy or sell) when requesting that the market be formed. And parties are solicited to respond with both sides of the market even in a case that the responding parties may be interested in only one type of trade and by responding with quotes for both sides of the market may commit themselves to making a trade at the quoted price, even if they were not initially interested in making a trade on that side of the market. Conventional OTC trading occurs on only a limited basis, such as where a salesperson makes phone calls and collects price information from potential counterparties for a single party that initiated a transaction, and only for the type of transaction that initiating party wants. By collecting market level information that includes both sides of the market and building a data store indicating both sides of the market for the financial instrument, some embodiments described herein enable a subsequent distribution of this information to additional parties to enable additional trading. This additional trading could not occur in conventional approaches, because information was not electronically collected on both sides of the market from every participant and thus the market level information was not available to be distributed to those participants in a second phase. The electronic collection and distribution of market level information is further enabled by a related third factor, relating to the manner in which the market level information is collected. To enable this solicitation of both sides, when users are solicited for whether they want to participate in the market, a minimum trade size for the dynamic market may be identified to the parties. This minimum trade size for the dynamic market may be an amount of the financial instrument that each party is obligated to trade at least that amount (and more if desired), if their quoted level for either side of the market is a match to any other party's quoted level (e.g., one party's buy price matches another party's sell price). The computer platform may enforce such a commitment by automatically executing a trade for the responding parties when such a match is detected. This commitment to trade has two advantages that overcome long-standing challenges in OTC markets: first, it means the parties cannot submit only teaser quotes which they have no intention of honoring and merely send for the purpose of “feeling out” a market for an instrument and learning something, and second, it means that parties have to think carefully about where they believe the market is for an instrument on both the buy side and the sell side, which combined with the second phase of the dynamic market discussed herein, enables greater information sharing, fairness, and liquidity in OTC markets than has possible with any conventional approach.

Third, when market level information is solicited, the computer-implemented system solicits the market level information on an anonymous basis, by not informing the solicited parties of the identity of the party initiating the market. This has advantages for the initiating party, who can be more confident they are receiving a fair deal rather than a deal that is influenced by their identity. But this has further advantages for the second phase of trading, since the anonymous market level information can be then shared with multiple additional parties (beyond the initiating party), since the market level information was not customized for any one particular party or specific trade. Relatedly, as discussed above, when the parties are solicited for market level information, the parties may be solicited to quote prices they would pay for at least a set amount of a trade in the instrument, which the system may automatically execute if a matching price is found. A party who is going to execute a trade may be given an option to trade more than that set amount if both the party and a counterparty desire, but the electronic communications soliciting the quotes for both sides of the market require both prices, for any counterparty (due to the anonymity), for at least the set amount. By collecting this information for trades on a generic basis (not linked to a particular amount nor linked to a particular party), and by collecting the information electronically, a data store of market level information may be assembled that enables sharing of market level information with multiple different participants in the second phase.

Fourth, the second phase is supported by computerized timers. In conventional OTC markets, when a party inquires about a potential trade and collects bids/offers, that party may be able to slowly evaluate their options and choose to trade or not trade. That may have been acceptable in a model in which only that party is going to be trading and the only one potentially impacted (other than their potential counterparties who may just decline a trade if too much time has passed). In some embodiments described herein, the initiating party is not given that option to slowly weigh their options. As markets evolve over time, collected market level information becomes stale. Computer technology is used in some embodiments to ensure the additional parties in this new type of dynamic market with this new type of second phase have a sufficient chance to execute trades in a second phase. Namely, a timer is started when the initiating party is presented with market level information and prompted to select a trade to be executed. The party may then have a chance to do so, and/or in some embodiments have a chance to negotiate a change to the terms of a trade with one or more potential counterparties. If the timer expires without action being taken, however, the initiating party's temporary control of the market expires and the market level information is distributed to further parties for trading by the other parties. This timer ensures that in this new type of two-phase market, the other parties have a chance to use the collected market level information and thus have access to the liquidity that this new type of dynamic OTC market can offer. Some such embodiments may include a further timer governing the temporary nature of the market. During the existence of the market, the computer-implemented system may facilitate trades by exchanging between parties' messages regarding trades and/or executing or facilitating trades for the parties. Once the timer expires, though, the computer-implemented system terminates the temporary market. Once the market is terminated, trading in the market is ended (even if participants desire further trades) and the computer-implemented system may no longer exchange messages between parties relating to the market and may no longer execute or facilitate trades for the parties. Accordingly, the second timer ensures the temporary nature of the market. The computer-implemented system may set and maintain these timers and communicate the timers to the parties in the system. In embodiments that include the timers, the timers may be for a fixed amount of time or may be a variable amount of time that is set based on criteria related to the dynamic market in which it is used. Such criteria may relate, for example, to the financial instrument on which the dynamic market is based, such as by having a longer timer for a more complex or less common instrument and a shorter timer for a more typical instrument. Other examples of criteria are discussed below.

The techniques for a MOD system described herein are enabled by a MOD platform and carried out using a MOD protocol. More particularly, the Market on Demand (MOD) trading protocol facilitates electronic trading between institutional wholesale financial market participants, and is implemented using one or more computing devices (e.g., servers) of an Electronic Communication Network (ECN). Using a MOD protocol, specific network communications are exchanged between specific computing devices of the MOD platform, including user devices of the market participants and one or more servers. Such specific network communications enable the unconventional trading activities described herein, including anonymity of market participants and two-phase trading in a dynamic market. Such trading activities of the MOD process, network communications of the MOD protocol, and devices of the MOD platform are described in detail herein. Examples of how a MOD-ECN may be implemented are discussed below.

In accordance with some techniques described herein, a MOD-ECN may facilitate the creation of market liquidity formation for a specific OTC financial instrument on behalf of a LR. This is a first phase of a MOD market for a financial instrument. This first phase may include several “mini-protocols,” which may leverage timers, validation, and eligibility for quotes and actions by participants. The timers and validation/eligibility parameters may aid in moving the process along in a fair and orderly manner to limit delays and prevent manipulation by any of the participants. The timers may govern a transition of trading and liquidity created in a first “Private Phase” in which an initiating party (e.g., an LR) has control over trading to a second “Public Phase” in which multiple parties (not necessarily the public, but may be a small group of parties such as those who responded to initial solicitations) to allow orderly follow-on trading with more participation from interested institutional trading firms.

In some embodiments, the MOD-ECN may take into account several factors in setting the timer(s) used in the different phases of a MOD process for a dynamic market for a financial instrument. Timers enable operating of the dynamic, temporary markets discussed herein, including by governing phase transitions and governing the temporary nature of the market, among other timers. While timers enable proper operation of functionality discussed herein, the inventor has also recognized and appreciated that fixed-length timers may undermine proper operation in some cases, as too short or too long a timer may prevent a second phase of the market from operating correctly. The inventor has therefore recognized and appreciated that dynamically setting length of the timer(s) may be desirable in some embodiments. The timer(s) may be set based on factors relating to the dynamic market being formed at a time, such as by relating to the instrument to be traded, the participants in the dynamic market, a time the dynamic market is being formed, and others. Illustrative factors include market conventions specific to the instrument, relative level of volatility of the instrument, complexity of the instrument(s), time of day, number of participants, available liquidity, market volatility, upcoming news and events, plus general market conditions. Complexity of the instrument may be measured in some embodiments by whether, for an instrument that is of a known type, one or more input attributes regarding the instrument to be traded deviate or not from known typical attributes for the instrument (e.g., nonstandard convention(s) for the instrument that make the instrument deviate in economic value from a standard instrument, examples of which for interest rate swaps include a change in the start date or end date from a standard period or using a different index to determine the variable rate). Having attributes that deviate from normal may lead to the instrument being flagged as more complex and lead to a longer length of timer. Complexity of the instrument may also be measured by a number or type of underlying instruments on which the instrument is based or from which it is derived, such that an instrument may be flagged as more complex when an underlying instrument is of a known complex type or when there are more than a threshold number of underlying instruments. Again, the MOD-ECN may assign a longer length of timer to a dynamic market for a more complex instrument. Available liquidity may be measured by an amount of trade conducted over a past time period (e.g., one day, one week, etc.) for the instrument or a type of the instrument, where more trading may mean the instrument is more liquid. The MOD-ECN may determine that a more liquid market is to be assigned a shorter timer, whereas a less liquid market is to be assigned a longer timer. A number of participants may also be associated with timer length, with the MOD-ECN assigning a longer timer for a dynamic market with a smaller number of participants and a shorter timer for a market with a larger number of participants. A level of volatility for the instrument or for the market in general may be determined from market conditions over a recent time period. The time period for measuring instrument volatility may be longer than the time period for measuring market volatility in some embodiments. For example, a time period for instrument volatility may be one day, two days, one week, etc. The MOD-ECN may determine a price volatility for the instrument or a type of the instrument over the time period. Where there is more volatility (e.g., during the time period, the price varies by a greater amount or varies more often), a longer timer may be assigned, and the MOD-ECN may assign a shorter timer for less volatility. Market volatility may be measured, for example, using existing indexes (e.g., Volatility Index (VIX)) that measure volatility in a stock exchange. While the dynamic markets discussed herein are for trade of OTC instruments, volatility in the exchanges may indicate general market conditions that may affect OTC trading. Market volatility may be measured on a shorter time period that may be, for example, 15 minutes, one hour, one day, etc. When the market volatility is greater, the MOD-ECN may assign a longer timer, whereas a shorter timer may be assigned for less volatility. For bespoke or illiquid customized OTC transactions, the LR may choose to provide manual parameters to seek trading liquidity. This may include manually setting a length of the timer(s), as part of submitting information regarding the instrument, minimum amount of trade, clearing and/or settlement processes, and other factors requesting formation of a temporary market.

The MOD process may begin when a user of the MOD-ECN system acts as an initiating party/LR to request formation by the MOD-ECN system of a dynamic market for a financial instrument. It should be appreciated that embodiments are not limited to operating in accordance with any particular financial instrument or type of financial instrument. In some embodiments, the financial instrument may be one that is not traded on an exchange, while in other embodiments the MOD-ECN may operate with any type of financial instruments that is to be traded between two parties in an OTC trade, including instruments that may otherwise be traded on an exchange. Examples of financial instruments with which embodiments may operate include OTC derivatives, structured notes, commodities, crypto currencies, physical debt obligations, registered and/or unregistered securities.

The LR may be a user of the MOD-ECN system and have registered an account with the system. Users of the system may be traders and may be associated with financial institutions. In some cases, users may be associated with dealers that may otherwise act in D2C or D2D markets or may be associated with customers that may otherwise act in D2C markets. In some cases, a user may be associated with dealer who trades on behalf of a customer that is not permitted to trade directly (e.g., a “sponsored access” relationship). Outside of the system, a person who is a user may otherwise be voice broker or a salesperson who trades in D2D or D2C markets. In some embodiments, individual users may also be authenticated to use the MOD-ECN system. This may be done in any suitable manner, including using industry standard techniques for authentication and permissions. Permissions may be granular and specific to an individual user profile. When a participant is an entity rather than a person, a compliance-approved profile may determine the participating entity's employee access to the platform and any pre-approved activities on the platform. This may include but is not limited to trading rights and/or any limits on trading activity or access to any module(s).

As mentioned above, the MOD process starts when a user acts as an LR to request formation of a dynamic market for trade of a financial instrument. The LR thus specifies to the MOD-ECN system the desired type of trade (buy or sell) and the financial instrument. In some embodiments, the MOD-ECN system may prompt the user to select a financial instrument or type of financial instrument from a set of defined financial instruments or types that may be traded via the system or to input a description of the financial instrument. To input a description, in some embodiments the user may input values for one or more attributes of the financial instrument to be traded in the dynamic market. The attributes may be attributes of financial instruments, and the values of the attributes may define a specific financial instrument. Such attributes may include: currency, timing attributes of an instrument (start date, end date, fixed or term obligation, etc.), payment attributes (amount or frequency of payment, interest rate, whether rate is fixed or variable, method of determining variable interest rate, method of calculating interest, etc.), reference instrument attributes (attributes of other instrument(s) on which the instrument is based, such as where the instrument is a derivative of another instrument, such as source of the reference instrument), notional value of the instrument, option attributes, and more. In some embodiments, a financial instrument that cannot be defined using these attributes may not be traded via the system. In other embodiments, however, the system may include an attribute indicating that the instrument has a complex structure or is a custom instrument, and a user may select that attribute together with some other attributes or when other attributes do not appropriately characterize an instrument. In some embodiments, rather than using attributes or in addition to using attributes, a MOD-ECN system may prompt a user to input an industry standard identifier for an instrument (e.g., a Committee on Uniform Securities Identification procedures (CUSIP) or International Securities Identification Number (ISIN) identifier).

In some MOD processes, a MOD-ECN sends out an electronic notice of solicitation on behalf of an LR to a number of LP(s) prompting the LP(s) to respond as a market maker by providing both bid/offer for the specified trading instrument for at least a pre-determined minimum trading amount. The MOD-ECN identifies the LP(s) to solicit based on a data store indicating the financial instrument(s) or type(s) of financial instruments in which each registered user is interested. When a user registers with the system and/or at a later time, the user specifies and/or changes the financial instrument(s) or type(s) the user is interested in trading. In some embodiments, the user may specify such interest by selecting an instrument or type of instrument from a list of instruments or types supported by the system. In other embodiments, the user may specify such interest by specifying one or more attributes and/or values or ranges of values for such attribute(s) in which the user is interested. The manner of indicating interest for a user may match a manner in which an LR may specify a financial instrument to be traded in a dynamic market, and the illustrative attributes mentioned above may be used in indicating interest. In some embodiments, to determine the LP(s) to be solicited to participate in a dynamic market, the MOD-ECN system may compare the input description of the financial instrument provided by the LR to the indications of interest maintained by the MOD-ECN for each user in the data store of interests. The system may compare instruments, types of instruments, attributes and/or values of attributes, or other information about instruments to identify a match. A match for an attribute or value may be an identical attribute/value or, where a range is provided in an indication of interest, a value for an instrument that falls within the range. When the MOD-ECN determines that an indication of interest from a user matches a description of a financial instrument for which a market is being formed, the user may be included in a set of LPs to be solicited for participation.

In addition to determining the LP(s) using indications of interest, the MOD-ECN may also determine, at a given time, what users are logged in to the system or otherwise active on the system. Users that are not logged in at a time may not be solicited at that time, even if the indications of interest for that user match an instrument for which a market is being formed at that time. If users specify working hours (e.g., a range of hours, time zone, etc.), then the user's working hours may be compared to the current time and a user may only be solicited if the time is within the working hours. If the user has not registered any activity with the system for more than a period of time, the user may be flagged as inactive and not solicited. In some embodiments, a user may be permitted to identify a “backup” user who may collaborate with the user and is authorized to conduct trades for the user or the user's clients/customers at times that the user is not active. In such a case, if a user's interests are found to be a match for the instrument for which a dynamic market is being formed but the user is inactive, another user who has been designated the “backup” for that user may be solicited—even if that other user has a set of interests that do not match the instrument for which the dynamic market is being formed.

The MOD-ECN system sends the identified LP(s) electronic communications via the system identifying the financial instrument, identifying a predetermined minimum trading amount, and prompting them to provide market level information for a trade of the instrument (a “Request for Market” (RFM)) in an amount matching the predetermined minimum trading amount. In accordance with techniques described herein, the solicitation does not identify the LR nor does the solicitation identify whether the LR would like to buy or sell the instrument. The market level information includes both buy and sell levels for the amount of the instrument. The solicited LP(s) have the option to respond or not, but the MOD-ECN may commit them to trading in the amount at the indicated levels if they choose to respond. The LP(s) respond by providing electronic communications back to the MOD-ECN system that include the levels chosen by each LP. The quoted levels from the LP(s) submitted electronically on the platform are collected and placed in a data store tagged with a system time stamp.

Receiving quotes for both sides of the market from each participant has advantages for building liquidity in the dynamic market. Generally, a participant will respond with a more aggressive quote for the side of the market that is their preference for a trade (a more aggressive buy price or a more aggressive sell price, as appropriate). A party's more aggressive price may be close to a current “fair value” of the underlying instrument in the wider marketplace, compared to quotes received from other parties less interested in trading. Once responses are received from a number of parties for both buy and sell prices, the more aggressive buy prices and the more aggressive sell prices can be identified and a narrowing of the overall order book can be identified. This benefits all participants in the marketplace when the order book is presented to them, as it allows for all parties to be more aware of what a current “fair value” of the instrument is. This stands in contrast to conventional “Request for Quote” (RFQ) approaches, where if a requesting party wanted to buy, only sell prices were solicited which would not allow for narrowing or informing participants of current values.

When the MOD-ECN determines a criterion is met (e.g., a minimum threshold of independent quotes are provided by different LP(s)), the system identifies the best bid (most aggressive buying level) and best offer (most aggressive selling level) for the financial instrument of the market, based on the quoted levels in the data store. In some implementations, when multiple LP(s) quote a same level for either a bid and/or offer price, then the MOD-ECN may use the system time stamp in the data store to determine the LP who earliest quoted the level and designates that LP as the party who designated the best quote for that side of the market (either bid and/or offer, as appropriate). The MOD-ECN then electronically communicates the best bid and offer from the respective LP(s) to the LR and prompts the LR to either trade at least the pre-determined minimum designated amount or respond with an order to counter the opposing bid or offer with a bid or offer that the LR believes is “better” than the prevailing “best” levels determined by the MOD-ECN from the quoted levels.

Collection of independent two-way quotes from multiple LPs may in some embodiments result in several scenarios. One scenario is that the best bid and best offer from independent LPs narrows the bid and offer level. Another scenario may result in one or more “crossed” levels. The levels “cross” when a bid (buying level) is either equal to or through the offer (selling level). When there are one or more crosses resulting from two-way prices provided from multiple LPs, the MOD-ECN system may take the mid-point resulting from the crossed levels and present this to the LR as a “choice” market. A “choice market” or “locked market” is where the LR can either buy or sell at the same quoted level. In this situation, the LR cannot improve on the prevailing bid or offer as they are at the same level, therefore if the LR is to trade, the trades at least the pre-determined minimum amount based on their preference to either buy or sell. The respective LPs are not harmed, as one of them will get a better trading level than what they quoted.

In some embodiments that set a “minimum” amount of an instrument to be traded in a dynamic market that is formed, the LR may be able to “Upsize” a trade during a first phase and seek a trade for more than the predetermined minimum amount for the market. Once the Upsize process is initiated by an LR, the MOD-ECN may prompt the LP to enter (within a limited amount of time) confidentially to the MOD-ECN system their full trading amount or otherwise a larger trading amount than the pre-determined amount that they are willing to trade at the initial quoted level. The LR's desired trading amount and direction (buyer or seller) has also been entered into the MOD-ECN by the LR, such as during the initial prompting for market formation or during the Upsize process. This information for the LR and the LP is stored in the database and retained in a confidential manner. If the LP has responded within the allowed time, the MOD-ECN system identifies the lesser of the LR's or LP's desired trading size as the amount to be traded at the LP's initially quoted trading level. Both trading counterparties are electronically notified by the MOD-ECN system of the total matched trading amount without disclosing any remaining imbalance (if any), resulting from one of the respective participants of the initial trade. In some embodiments, all other participants of the dynamic market (e.g., the other parties that responded to the MOD-ECN's initial solicitation for the market) are notified of the trading level as the system transitions into the second phase (sometimes referred to herein as the “Public Phase,” though it is not limited to being open to the “public”).

As should be appreciated from the foregoing, a second “Public Phase” may follow that initial “Private Phase” in which only an LR and a chosen counterparty may trade. In the second phase, all the LP(s) orders with original timestamps from the solicitation process which have been maintained in the database may be eligible, if they are live and active under the control of the respective LP(s), for viewing by other participants in the dynamic market. The orders may be distributed to the other participants during the second phase using a Central Limit Order Book (CLOB) structure and rules, which may sort the quoted levels based on price then time priority. The original LR and LP with any remaining unfilled hidden trading amount may retain their position at the top of their respective side of the order book, which is consistent with those levels having been selected during the initial “Private Phase” as the “best” quotes. In the second phase, all quotes may be live orders within the order book for the pre-determined minimum trading amount.

In some embodiments, only the LP(s) that responded to the solicitation for the dynamic market may participate in the Public Phase. In other embodiments, all LP(s) that were solicited are permitted to participate in the Public Phase. In still other embodiments, all members of the public may be permitted to participate in the Public Phase, or an otherwise larger set of users than those who were solicited to participate. In some embodiments in which the public or a larger set of users may participate, the original LP(s) from the Private Phase solicitation process (those who responded and/or who were solicited) may have priority over any subsequent orders that join the order book in the Public Phase, giving those LPs an ability to trade before others. In some embodiments, only the trader(s) with live active orders gain visibility in the disclosed stack of orders within the active order book. The MOD-ECN may regulate communications in the system to effect these participation constraints and ensure that only certain parties participate in the second phase or at certain times of the second phase. For example, the MOD-ECN system may not communicate electronic messages in the dynamic market to or from parties that are not to be active in that market at that time, such as by refusing to receive messages and/or refusing to deliver messages, such as trade messages. In addition, the MOD-ECN system may not distribute market level information to parties that are not to be participants in the second phase.

In the second phase, prices that match (i.e., a sale price for one party is a match to a buy price for another party, which may mean the sale price is less than or equal to the buy price) are potential trades or, in some embodiments, may be executed by the MOD-ECN automatically upon detection of the matching prices. Such trades may be, by default, for the pre-determined minimum trade amount. In some embodiments, when a trade is detected or is to be executed, both the traders may be given an opportunity to Upsize their trading amount, using the procedure described above. In some embodiments that include the Upsize process in the Public Phase, the MOD-ECN may impose constraints on further trading by the parties to a detected trade, such as by requiring that the Upsize process for a particular trade between a particular pair of traders be performed for these matched trades (including a declining of Upsize, if the traders choose) before those two parties can complete any other trades (in the instrument on which the dynamic market is based) with other traders. To impose the constraint, the MOD-ECN may not accept input of another trade or may not exchange communications regarding another trade until the Upsize process is completed. The MOD-ECN may regulate access to trades listed in the CLOB beyond requiring certain steps be performed in a certain sequence. For example, in some embodiments, a trader whose full desired trading amount has been filled in the market (e.g., either filled in an initial minimum trade or in an Upsize process) loses their priority in the ordering of traders and cannot trade until other traders with higher priority have completed trading. However, a trader who has not yet traded an amount matching a (confidentially disclosed) larger trading amount retains priority in the ordering of traders, such that the MOD-ECN facilitates further trading by that trader in follow-on trading with other traders in the second phase.

In some embodiments, the MOD-ECN system requires an LR or an LP that participates in the dynamic market (e.g., by triggering formation of the market or quoting a trade in the market) to agree to trade at least a predetermined minimum amount of trade in the market, and the MOD-ECN may enforce this by automatically flagging matching prices for parties and communicating with the parties about the match and the potential trade, or automatically executing trades. This constraint in these embodiments, preventing communicating about or participating in the market without that agreement to make the minimum trade, prevents “spoofing.” Spoofing is a form of market manipulation in conventional markets, where a party contacts other parties (by phone, in a conventional system) and indicates interest in trading a large trading amount, but without the intention to trade. Rather, the party intends the large trade amount to influence prevailing prices and other participants' behavior. Spoofing cannot be regulated in a conventional market that occurs by phone or can be regulated only by human traders declining to call or believe certain other traders who are known for spoofing. In some embodiments, the MOD protocol of the MOD-ECN system prevents manipulation by associating all orders with the established minimum amount for the dynamic market for a financial instrument, and in some embodiments by automatically flagging or automatically executing trades for that amount. In addition, the Upsize process keeps a desired trading size (e.g., an amount higher than the minimum) confidential from the opposing trader or any other participants on the ECN. The Upsize match is constrained by the smaller amount between the two trading entities. Any imbalance or unfilled amount is confidentially maintained within the system in a data store associated with the user, and not disclosed to other parties. An open order is distributed to parties and displayed during the second phase for the predetermined minimum trading amount, by default.

The MOD-ECN may maintain a live active trading order book in the second, “Public Phase” for each unique and distinct OTC instrument until a timer for the dynamic market formed for the instrument expires, after which the market terminates and the MOD-ECN will no longer communicate messages regarding the market or trades in that market. In some embodiments, a MOD-ECN system may maintain multiple MOD sessions in parallel. Each of the multiple MOD dynamic markets at a time would relate to a different financial instrument and including a different set of participants (though individual users may choose to participate in multiple dynamic markets at a time, to trade in different instruments). The different markets may have other different attributes as well, such as different clearing parties/destinations or settlement procedures. At a given time, different markets may be at different stages of the MOD protocol and be being run by the MOD-ECN system. Each market may operate on an independent timer for when the market will be terminated, with each market terminating at a different time. (And different markets starting at different times in response to an inquiry from an LR.) A MOD-ECN may determine in some embodiments whether and when to terminate a market based on whether an order book for the financial instrument of the market has gone “stale.” An order book becomes “stale” when it is no longer viable to support follow-on trading based on the order book. A MOD-ECN system may use factors such as insufficient orders, insufficient participants, and no price improvement (insufficient narrowing of the bid/offer spread over a specified timeframe) to determine whether to terminate a market.

The MOD trading platform according to techniques described herein may be able to facilitate a fair and orderly process for the anonymous solicitation of liquidity, price negotiation if desired, increasing the size of the trade if desired, and follow-on trading amongst participants for institutional OTC markets if desired. The MOD-ECN uses embedded algorithms and technology to create flexible timer(s) that help facilitate the timely progression from one phase to the next as well as moving sub-processes within the phases. In addition, if the minimum requirements for trading and liquidity creation are not available, then the algorithm will terminate the process using pre-configured timer(s) for notification to end the process, phase, or the entire MOD session for that specific request.

A concrete example may help elucidate some advantages of some embodiments described herein. In some embodiments, a responding participant “wins” the initial trade with the LR that results from the formation of the dynamic market for the instrument (and any subsequent Up-Sizing) when the participants market level information (included in that participant's solicitation response) meets key factors. The “winning” LP in these embodiments will have the best “level” for the trade (e.g., their market level information will indicate the lowest offer to sell or the highest bid to buy) and that LP will be the first responding participant to indicate a willingness to sell or buy at that level. Any LP that responds to a solicitation with a buy and/or a sell level that is better than the existing or subsequent prices provided by the rest of the liquidity pool would be placed by the MOD-ECN at the “top of the stack” for trading in that market. Any other LP who submits but is received by the MOD-ECN with a later time-stamp will be second in line and will not be selected for a trade during the first phase of the dynamic market. However, as second place in line, that other LP will have first priority in the second phase to trade with the LR and upsize, should the trade with the first LP not satisfy the LR's desired trade size, or trade with other participants at that level in the second phase.

It should be appreciated that being the first participant to respond at a price level does not guarantee a trade—another LP may show an improved level. However, being first in an overall stack when the solicitation phase ends leads to a trade at the quoted level if the LR trades during the first phase or if there are other participants who want to trade at that level in the second phase.

Those skilled in the art will appreciate that, conventionally, “first” or “best” price did not play a leading role in trade selection and execution, despite that laypeople may suspect otherwise. Rather, in the interdealer broker (IDB) world, the winner of the trade is decided by human factors that are typically nebulous, inconsistent, and unclear. This has ensured that OTC markets have always been unfair, inefficient, and worthy of mistrust, which has long undermined liquidity in the market. In contrast, some embodiments described herein leverage computer technology that enables consistent use of timers and include operations that require an LR to trade, counter, or lose the controlling position to the start of the second phase, making the resulting two-phase dynamic, temporary market more liquid and consistent for all.

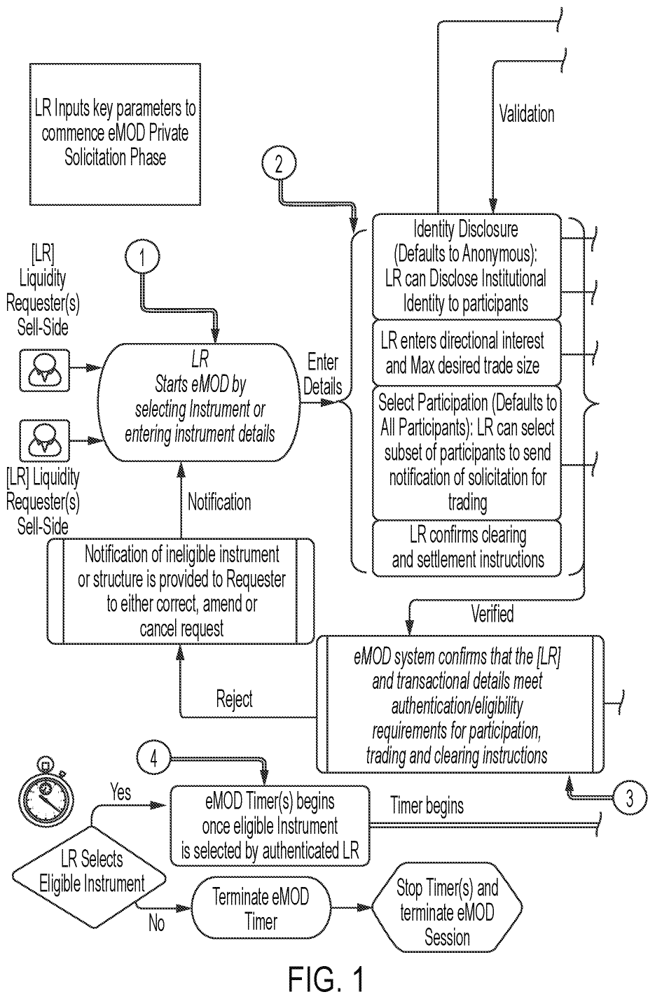

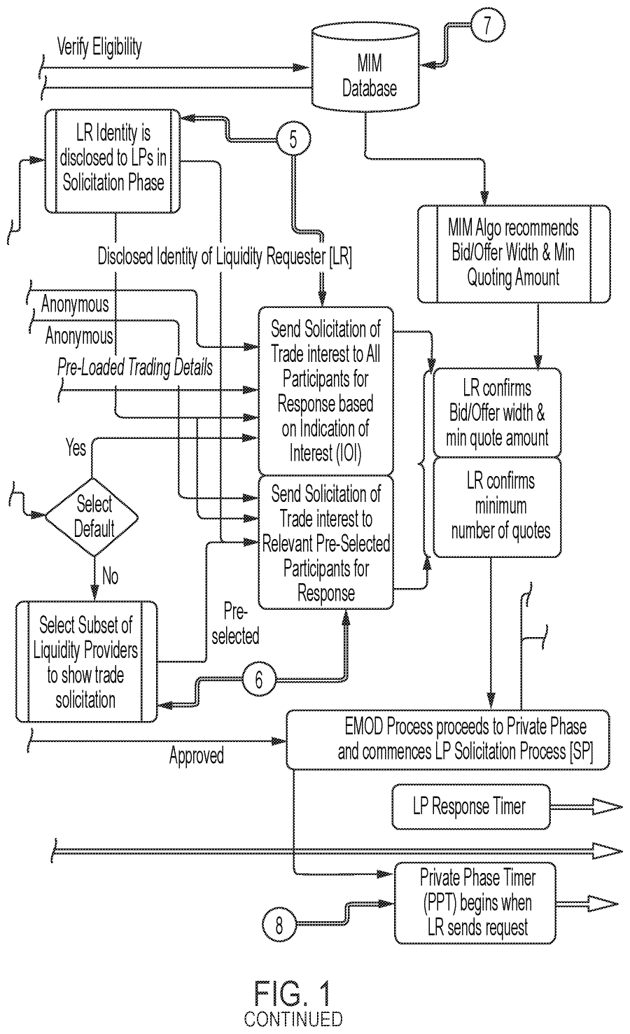

Techniques that may be implemented in one embodiment of a MOD-ECN system are illustrated in FIGS. 1-7. Corresponding numbers in the provided drawings are to explain the various step within the phases. FIGS. 1-7 illustrate one example of one MOD process; however, different instruments can coexist independently and may start concurrently or separate to any pre-existing MOD process. It should be appreciated that other embodiments may be implemented as well, as embodiments are not limited to operating in accordance with FIGS. 1-7.

FIG. 1 illustrates a flowchart of an initial process to start the MOD protocol for trading an OTC financial instrument(s). Block [#1] depicts that a Liquidity Requestor (LR) can be either an institutional customer or a dealer, as in some embodiments the MOD system accommodates both customers and dealers and does not segregate the D2D and D2C markets. To begin the process, the LR inputs to the system a description of the financial instrument for which a market is sought, which may include selecting an eligible standard OTC instrument or entering appropriate descriptors for an instrument or selecting standard OTC instruments for the specified asset class (for example: TIIE Interest Rate Swaps, USD Swaptions, or Non-Deliver Forwards). Such descriptors may include attributes of the instrument, examples of which are discussed above.

Block [#2] illustrates that an LR is prompted by the MOD system to input additional information regarding an OTC market to be formed. This additional information may be chosen by the LR based on client preference in some cases, or required by regulators in other cases, or in further cases necessary for clearing and settlement processes. Such information includes whether the market is to be anonymous (default is anonymous), what type of trade is sought (buy or sell), what the desired trading amount is, what other parties are to be solicited or not to participate, and clearing and settlement instructions including who the central clearing counterparty (CCP) is.

Once the LR enters and confirms these parameters, the system at block [#3] validates the market and the eligibility of the instrument and conditions for solicitation, responses, and trading. Such validation by the MOD system may leverage eligibility criteria established by the CCP, in some embodiments. If the instrument and other parameters for the market satisfy CCP criteria, then matched trades in the market will be sent to the CCP for processing and clearing. Because the CCP is the central counterparty to all matches trades, the MOD system enables creation of a dynamic market with the LR's specified attributes, which match the CCP's acceptance requirements. An electronic notification is sent to the LR to either amend or withdraw the request if any parameter(s) are not suitable for proceeding, e.g., because the CCP's criteria were not met. One factor that may be checked during validation is whether a market already exists for the specified instrument. In some embodiments, in addition to CCP criteria, the MOD system may examine MOD-specific factors. For example, in some embodiments, the MOD system may not permit multiple markets to concurrently exist for the same instrument, or in some embodiments will not permit concurrent markets for an instrument unless the instrument is part of a portfolio or structured trade request. In such a case, the MOD system may examine the specified attributes of the instrument and/or of the market being requested and compare those to ongoing dynamic markets. If the MOD system determines the instrument is the same or meets criteria for identical or matching attributes with an instrument for an ongoing dynamic market, the MOD system may decline to form a new market. Or, if the MOD system determines such a match to an instrument for an ongoing market, the MOD system may form a new market only if the new market would differ from the ongoing market in other attributes, such as if the identity of the CCP is different for two dynamic markets that otherwise match (e.g., identical instruments).

Upon confirmation of instrument eligibility (either initially or following an amendment), at block [#4] the system starts an eMOD timer and thus starts a market session for this specific instrument. The market will only exist until the MOD system determines this timer has expired or determines earlier that another criterion for terminating a market is met.

Blocks [#5] and [#6] are examples of how an LR's preferences may be handled by the MOD system, when permissible under regulatory rules governing the specific OTC asset class. At block [#5], the LR chooses for the MOD system to disclose the LR's trading identity to LP(s) when soliciting quotes for the requested instruments. The default case for MOD-ECN is to preserve anonymity of all parties involved on the platform, but at block [#5] a configuration setting is made to include the LR identity in solicitation messages or a message is sent as part of a solicitation that indicates the LR identity. Block [#6] is an example of the LR choosing a pre-selected group of LP(s) to consider for receiving a solicitation. The default case for the MOD-ECN is to determine from among all users of the system those LP(s) who are available, eligible to trade the specific instrument, and have provided in block [#10] their Indication of Interest (RN) to receive solicitations for certain instrument(s) or type(s) of instruments within the MOD-ECN. At block [#6], the LR may instead identify a different group of users (e.g., by desired association or other characteristic of the users) those users for which a determination of availability, eligibility, and interest is to be made to determine whether to solicit them for participation in the market.

The LR may enter and/or approve parameters for starting the Solicitation Process (SP), which includes: approving a number of quotes to be received before a BBO is identified from market level information; entering desired trading size; indicating if the LR intends to be a buyer or seller; and approving minimum quote parameters. The minimum quote parameters may, in some embodiments, be determined by the MOD-ECN Market Intelligence Module (MIM) at block [#7] and presented to the LR for approval. The MIM may collect market data and store market conventions for OTC instruments to be used in determining, for later dynamic markets, quote parameters for the markets. Such quote parameters may include a default minimum trading amount to be supported by each quote provided by the LPs, and that forms the default trade size for trades executed in the first and second phases (prior to any upsizing). The trade amount may be determined by the MIM of the MOD system through an analysis of liquidity in the market. Because traders often do not want to make outlier trades (too large or too small) in a market for fear of causing sudden volatility in the market, the MIM may monitor trade in an instrument or type of instrument and set a target amount based on that trade activity. For example, the MIM may calculate a statistical value reflecting recent trade amounts, such as a median or average amount of trade. The MIM may then set the trade amount to that statistically-calculated value or to a fraction of it, such as to one-quarter of the statistically-calculated value, one-half, etc. The trade parameters may also include permitted quote width, which is the permitted spread between a responding LP's bid and offer in their response to solicitation, as well as a recommended quote width. In some embodiments, as described below, the MOD system may reject an LP's response for including two levels (a buy level and sell level) that are too far apart, which an LP may try to do in an effort to submit what is truly a one-sided quote by having a second side that is so far outside of reasonable that no other party would trade at that level. The MIM of the MOD system may identify the minimum or recommended quote width by analyzing past spreads in dynamic markets for the instrument or a type of the instrument, to identify quote spreads that lead to trades in a dynamic market. The MIM may, for example, identify an average quote width in past dynamic markets for that instrument or a type of the instrument as the recommended quote width, and a value calculated past on the average (e.g., 50% more than the average) as a maximum permitted quote width.

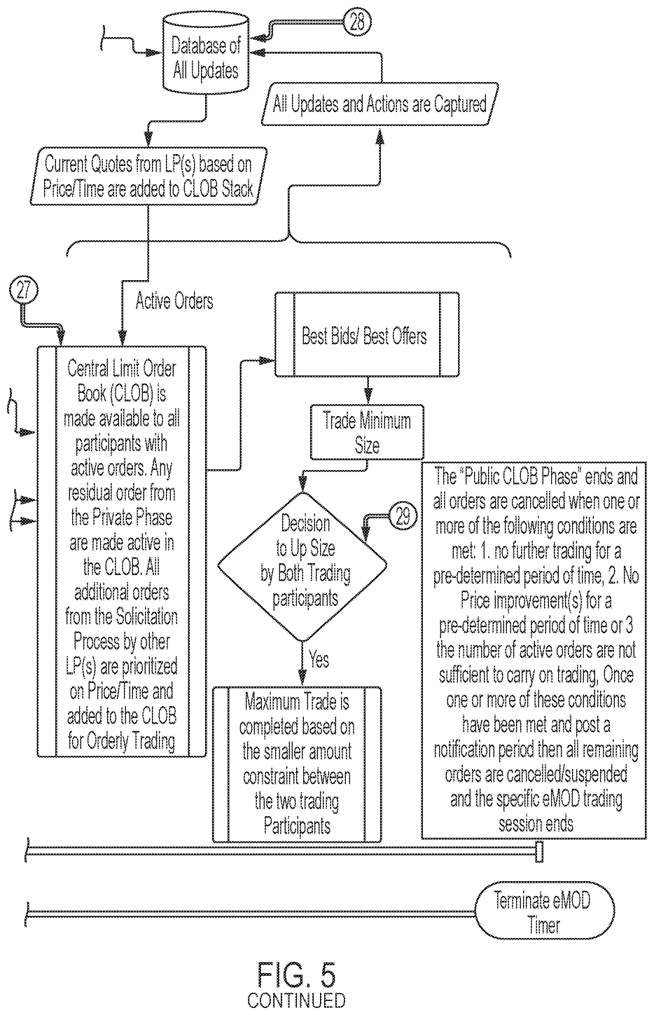

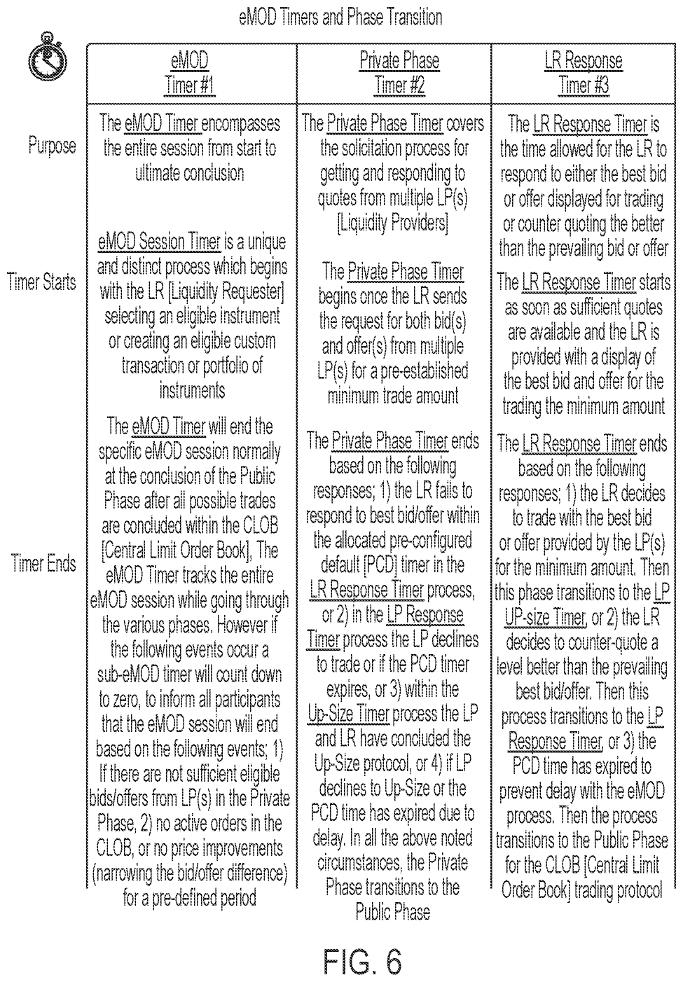

The LR has control as to the start of the Solicitation Process (SP) for sending the request to the approved LPs [#9]. The release of the request by the LR will cause the MOD system to start a Private Phase Timer (PP-PCD Timer) [#8, see also FIG. 6 Column #2] within the Private Phase.

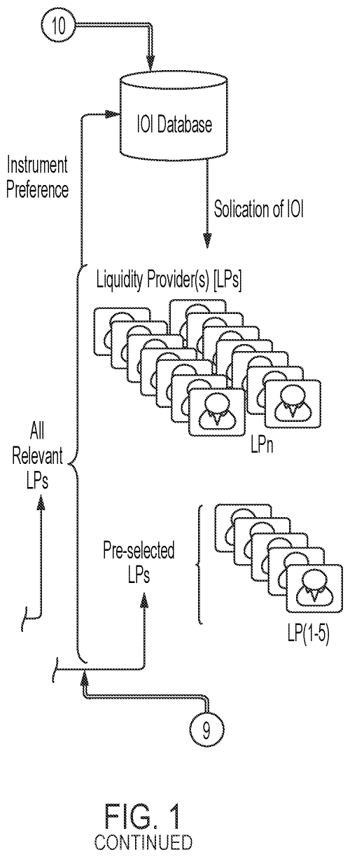

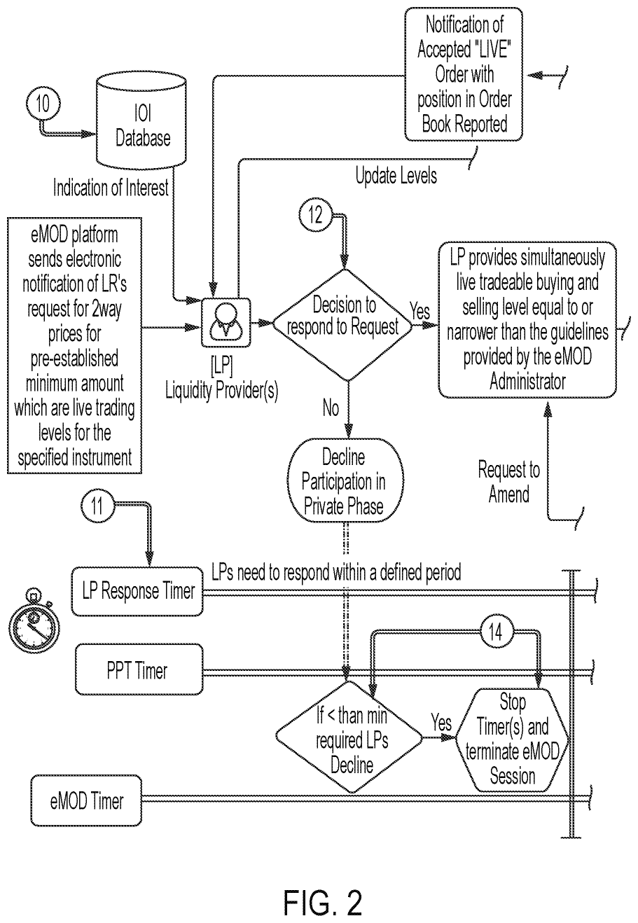

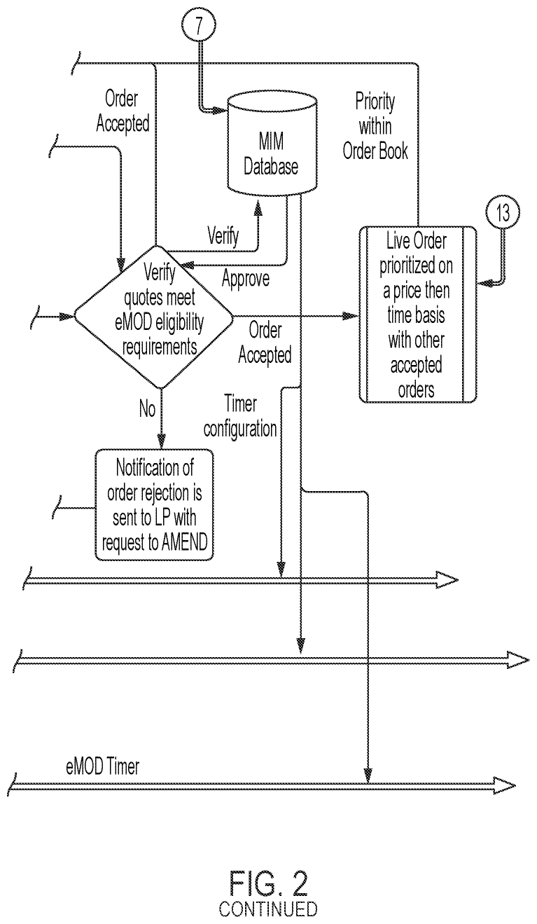

FIG. 2 illustrates a flowchart for a Solicitation Process (SP) within the Private Phase and the LP response process, which follows in time the process of FIG. 1. The MOD system leverages the IOI Database [#10] to determine the LP(s) to which it will send the solicitation for each determined LP to provide a Request for Market (RFM) for the specified OTC financial instrument.

If the LP chooses to respond to the request, the LP communicates to the MOD system both a bid level and an offer level for the pre-determined minimum amount of the financial instrument for which the market is based and that is identified in the solicitation.

The MOD system starts an LP Response Pre-Configured Default Timer (LP-PCD Timer) [#11, see also FIG. 6 Column #4] with the release of the solicitation by the LR. If an LP does not respond before expiration of the timer, the LP-PCD Trimer will time out based on the pre-configuration data (PCD) and the MOD system will not accept a response from that LP (but may accept responses from any other LP that responds before expiration of the timer).

In some embodiments, the MIM of the MOD system may use the PCD in block [#7] to determine timer configuration based on multiple factors including but not limited to; instrument complexity, market volatility, participation, liquidity, and time of day, or other factors discussed above. As should be appreciated from the foregoing, different OTC instruments have different levels of complexity. For example, some instruments are viewed as being generic or standard (“On-the-Run” or “vanilla”) reflecting that many traders would have a high degree of familiarity with standard attributes of the instrument and with how to value the instrument. Other instruments may not be standard (“Off-the-Run” or “customized”) reflecting less common attributes and thus one that traders would likely be less familiar with and thus that may have less liquidity. Due to the lack of familiarity and lack of liquidity, these instruments may require more time to price to gain sufficient participation. In this case, the MOD system will assign a longer timer length, and will assign a shorter timer length for more common instruments. Concerning market volatility, participants in some cases may have difficulty in pricing OTC instruments if the underlying market conditions are highly volatile. In these circumstances, it might be appropriate to allow LPs more time to quote, in addition to widening bid/offer spreads and lowering the minimum amounts quoted. Accordingly, the MOD system will assign a longer timer length in times of volatility in the market at large and/or in the market for that instrument or type of instrument, and a shorter timer length otherwise. Regarding time of day, it might be appropriate to lengthen the timer if the LR is requesting an instrument before or after normal working and trading hours, and assign a shorter timer length during regular working/trading hours.

If an LP responds to the RFM, then the MIM may next verify that the response(s) from the LP(s) comply with parameters pre-established for the specific instrument, such as the quote width parameters discussed above, or whether the trade amount is an amount lower than a predetermined minimum for the market. In some cases, the MIM may also determine whether price volatility (for the instrument, or in the market in general) has increased since the dynamic formation of the market began and, if so, determine that the prices are changing too quickly for the dynamic market to be maintained at the current time. If responses are verified, the MOD system inserts the quotes into the order book at block [#13], at positions in the book based on CLOB rules of price and then time rules. If, however, the MIM of the MOD system were to determine that the response(s) from the LP(s) or the price volatility do not meet criteria for the market, the MIM will at block [#14] start the count down for the termination of the dynamic market for the specific instrument. Some examples that may result in the MIM terminating the dynamic market prior to any trades being considered or executed include: the session does not have enough quotes, the quotes are wider than the maximum acceptable band, a majority of the LPs have timed out, and others.

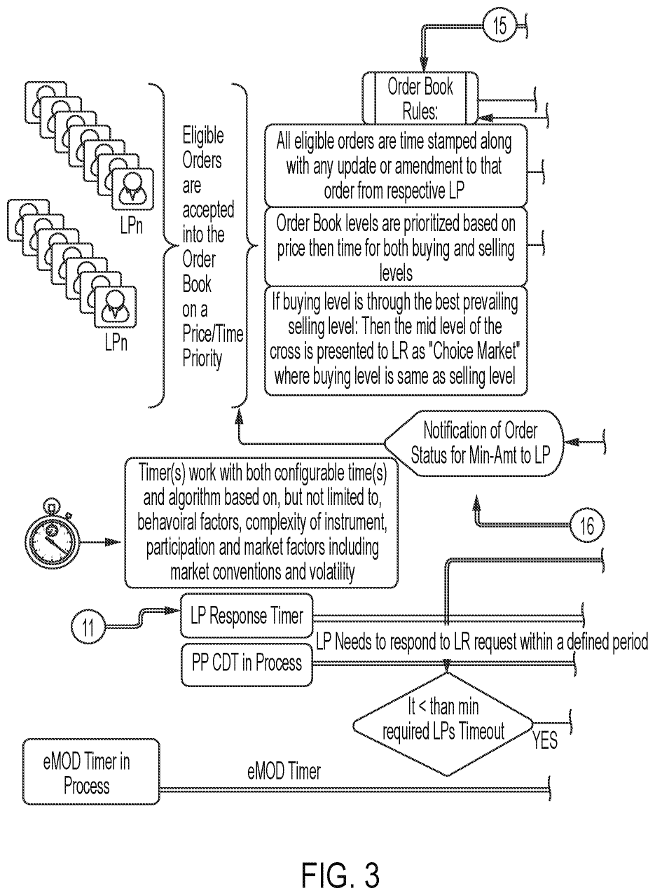

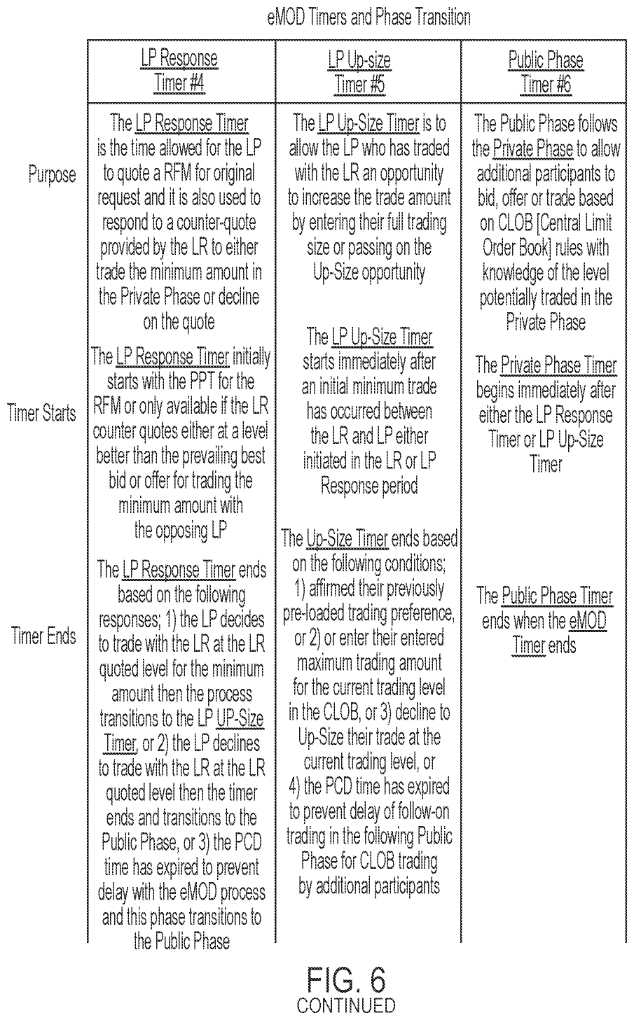

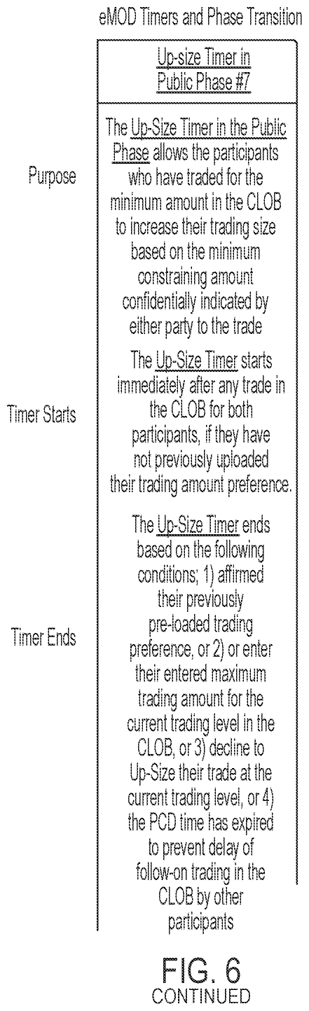

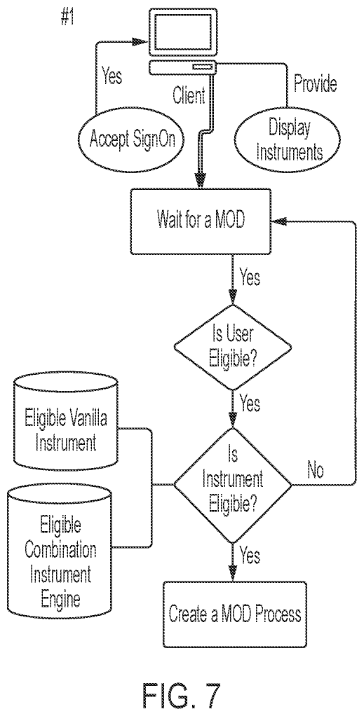

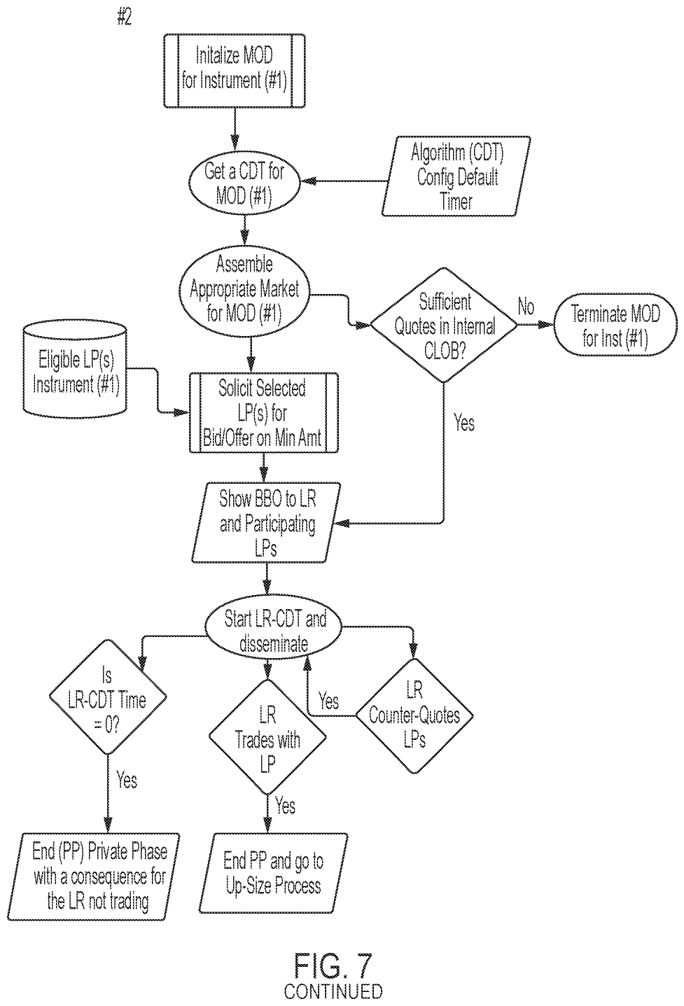

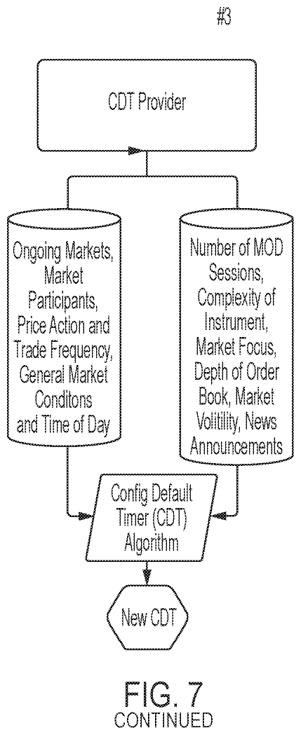

FIG. 3 illustrates a flowchart for creation of the order book with sufficient eligible orders from the required number of LPs, a process which follows in time the Solicitation Process of FIG. 2. The MOD system processes responses from LPs in accordance with a sample of Order Book Rules at block [#15], which are maintained within a MOD-ECN database. The MOD system stores in the database all updates and amendments from the LPs during the LP Response process within the Private Phase. At part of doing so, the MOD system time stamps all eligible orders from responding LPs in the database. The system prioritizes orders in a price-time ladder to determine best bid/offer (BBO) from the respective LP responses. The MOD system may notify responding LPs of their respective position in the order book at block [#16], including the LP(s) that are top of the stack ladder. When the minimum number or quotes exceeds the threshold, (e.g., three or more for “Best Execution” requirements for most institutional Asset Managers), the MOD system outputs the BBO for display to the LR at block [#17] and starts a LR Response Timer at block [#18, see also FIG. 7 Column #3]. In accordance with MOD techniques described herein, the LR needs to respond to the BBO within the LR Response allotted timer.

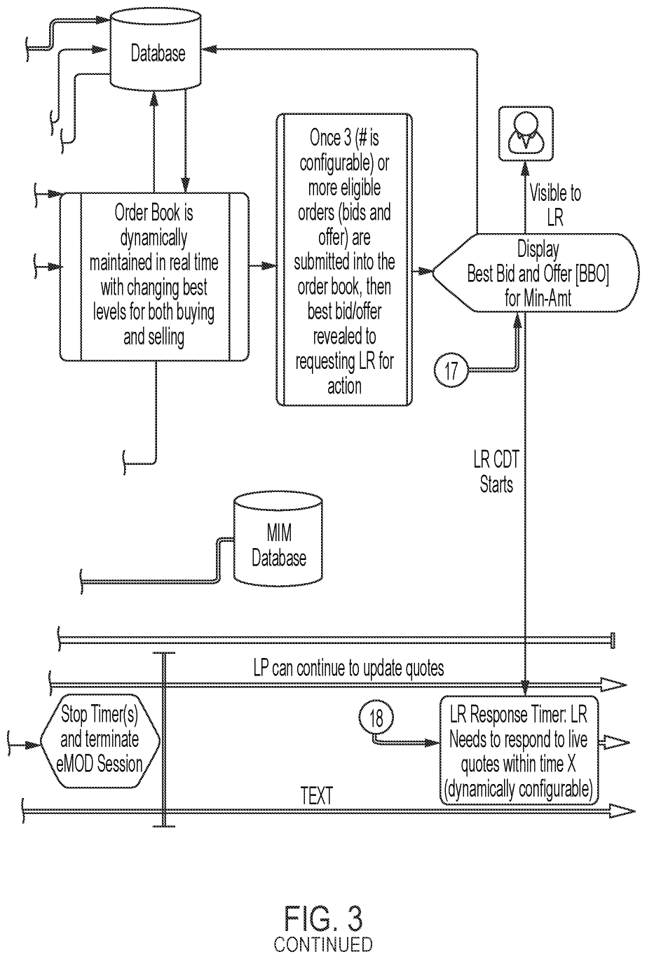

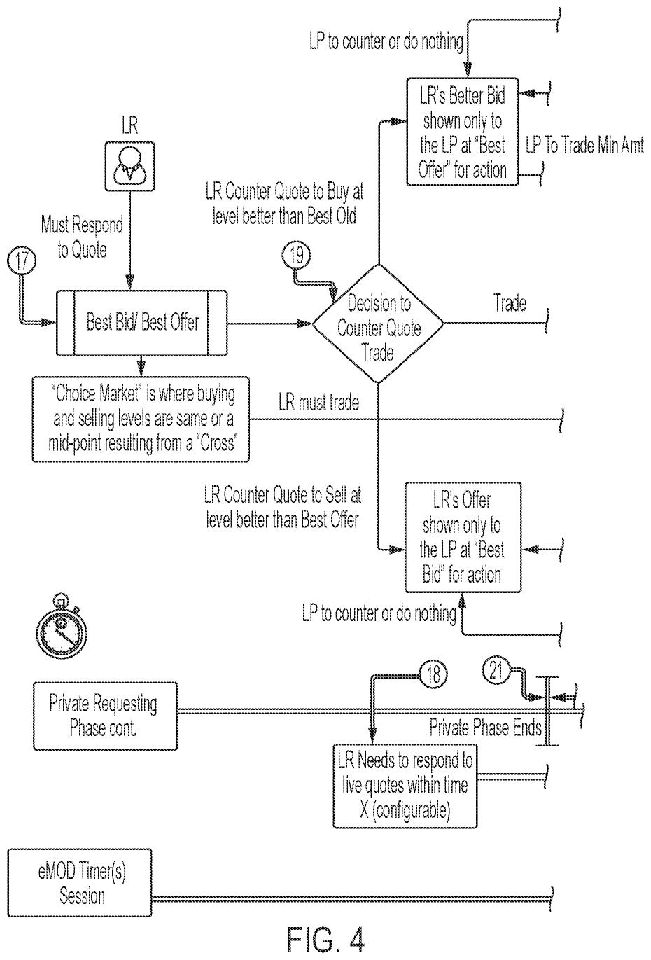

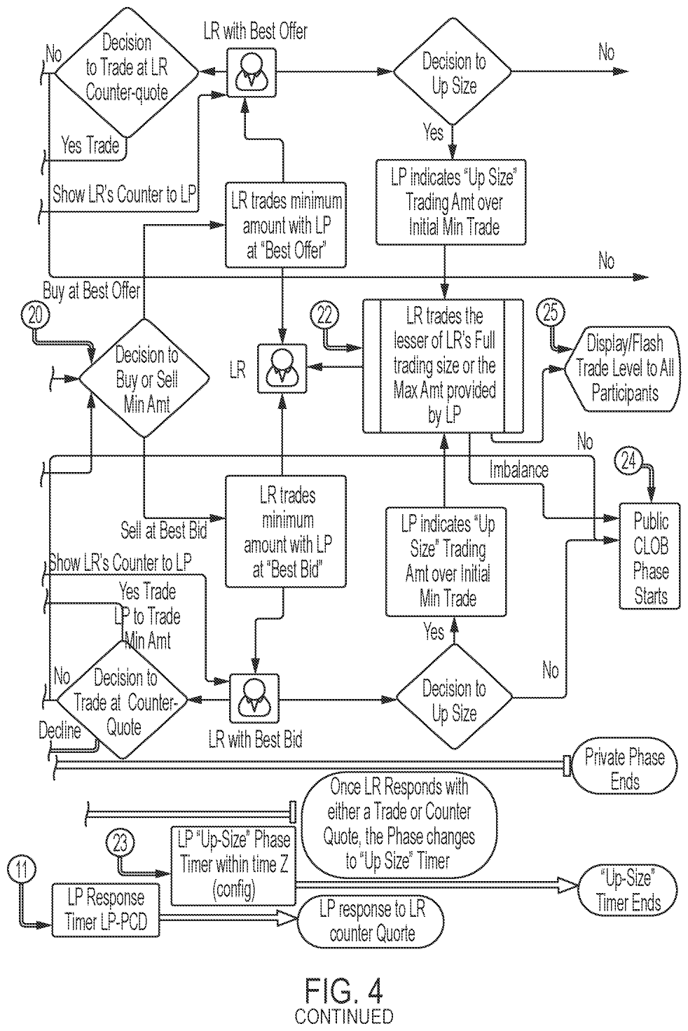

FIG. 4 illustrates options for an LR's Response once they are presented with the BBO at block [#17]. The LR can choose to counter quote at block [#19] by inputting to the MOD system a better price than the prevailing bid or offer, which the system will communicate to the counterparty LP for the current-best bid or offer for the LP's consideration. Alternatively, at block [#20], the LR can choose to trade at the available level provided by the LP(s) for the minimum amount.

If the LR chooses to counter quote better than the prevailing BBO, then at [#11] the MOD system starts an LP Response timer on a pre-configured timeframe. Within that timeframe, the LP must decide to either trade at the counter-quote provided by the LR or decline. If the LP declines, then at block [#21] the MOD system ends the Private Phase and transitions to the second phase that operates under CLOB rules.

If at block [#20] the LR chooses to trade with the LP at the LP's originally-specified level, then at block [#23] the MOD system starts an LP Upsize Timer. The LP Upsize Timer is designed to allow a limited time for the LP to increase the trading size at the original initial trading level without holding up the dynamic market. The LR may have already confidentially input their desired trading amount (e.g., [#2] of FIG. 1), or may be prompted by the MOD system to do so. The LP also determines and inputs to the MOD system the amount that they would like to trade, without knowledge of the LR's preferred trade amount. The MOD system identifies the lesser amount between the confidential LR trading amount and LP trading amount as the new trade amount between the two parties (LR/LP) at the initial trading level. The MOD system discloses at block [#25] the trading level, but not the trading amount, to other parties before starting the Public Phase. These parties may include the LPs that were solicited to participate in the market and additional participants on the ECN.

If the LR or LP desired a trading amount that was larger than what was traded, then at block [#24] the MOD system prioritizes the participant with the unfilled balance at the “Top” of their respective stack for follow-on trading in the Public Phase. If the LP decides not to Upsize, then the Private Phase ends and transitions directly to the Public CLOB Phase with the LR, if they have an unfilled balance, at the top of their respective stack. If, however, the LR does not counter quote and decides to trade at the BBO LP level, then at block [#23] the MOD system starts the LP Upsize Timer and the Upsize process follows the same process as mentioned above. If either the LR or LP do not make a proactive decision within their respective timers, then the Private Phase ends and goes directly to the Public Phase with the MOD system at block [#25] sending a notification “flashing” of the trading level to active participants on the ECN.

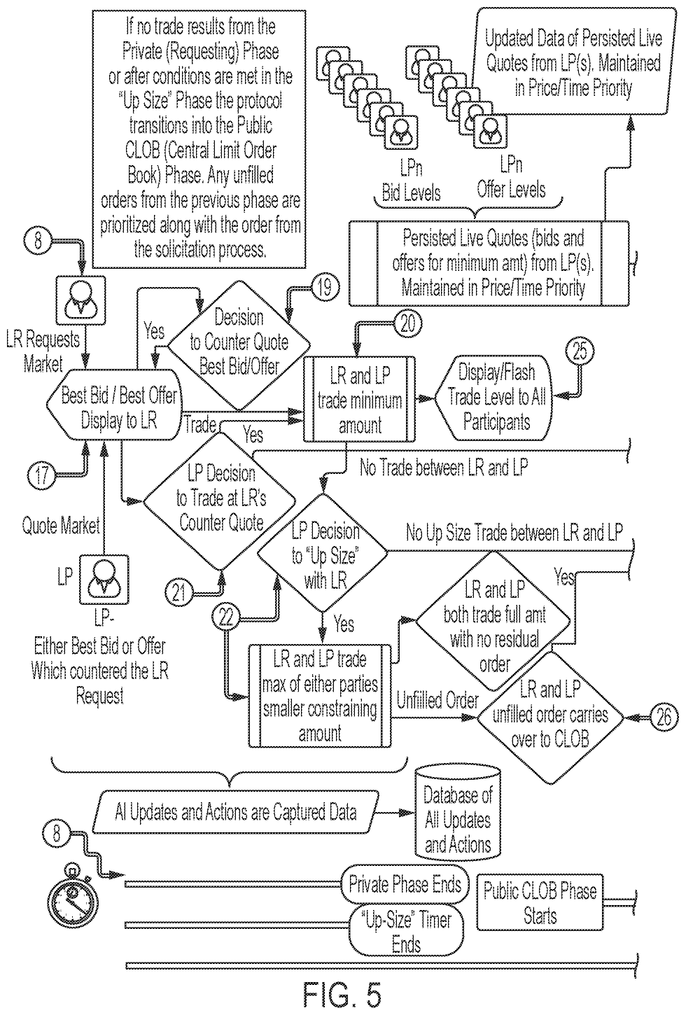

FIG. 5 illustrates a flowchart of events that change the Private Phase to transition to the Public CLOB Phase, which follow in time the process of FIG. 4. To reiterate preceding events addressed above, which are shown at the start of the process of FIG. 5: The LR requested an RFM from LP(s) at block [#8]. LP(s) responded by quoting a bid and offer for the indicated minimum amount; the MOD system identifies and outputs the BBO at block [#17] to the LR, who decides whether to trade [#20] or counter-quote [#19]. If the LR counter-quotes better than the prevailing BBO, then at block [#21] the LP must decide to trade at LR's counter-quote or decline. Were the LP and LR decide to trade either at the original BBO [#20] or at LR's counter-quote [#21], the MOD system progresses to the Upsize process at block [#22]. The LP has a limit time window at block [#23] to determine their preferred trading amount at the prevailing trading level. The LR and LP will then at block [#22] consummate the maximum trade amount available, constrained by the LR minimum hidden size and the size shown by the LP. After the LR Counter Quote process without Upsize, or the LR and LP conclude the Upsize trading from the original BBO, the MOD system provides a notification of the trading level, if available, to other participants at block [#25]. This signals the end of the Private Phase and transition to the Public CLOB Phase at block [#27].

In the Public Phase, any unfilled trading amount between the original LR/LP from the Upsize process is maintained confidentially within the MOD system, and at block [#26] the MOD system gives priority to an unfilled trading order at the top of the order book in the CLOB BBO. Any of the LP(s) that have continued to persist their quotes from the initial Solicitation Process (SP) are retrieved from the database by the MOD system at block [#28] as per price/time order book rules within the CLOB. The MOD system gives these original LP(s) orders priority over any new orders, from additional participants in the Public Phase, based on their earlier timestamp. Depending on the market convention and regulatory requirements, the CLOB stack will be visible to participants along with the position of their respective order(s) within the CLOB. The CLOB process may follow normal exchange-based trading rules, or in some embodiments normal rules with the exception that after each trade the two parties, buyer and seller, are allowed a limited time to Upsize their trade at block [#29] over the stated minimum order size to maximize preferred trading amount, following the upsize process discussed above. If the participants have not pre-entered their desired full trading amount, then both parties using the LP Up-Size Timer rules [Up-Size-PCD Timer, FIG. 6 Column #5] are confidentially able to enter their preferred trading amount to the MOD system. The MOD-ECN will match the amount using the minimum constraining amount to conclude the trade. The participant who still has a remaining amount to trade keeps their position in the CLOB, while the participant that has no further trading amount is removed from the active CLOB. Follow-on trading continues until the MOD system determines with the eMOD Timer [FIG. 6, Column #1] that the session has gone stale with no additional trading and/or no further price improvements (narrowing of the bid/offer spread) for a period of time determined by the algorithm.

FIG. 6 illustrates timers used in some embodiments of the MOD-ECN. OTC markets for institutional size trading require adequate time for the participants to make trading decisions on large trades with substantial risk transference implications. However, the time is not static and needs to assist the participants to prevent unnecessary delays to the smooth transition of the mini-processes used within the MOD-ECN. Delays can put the opposing trading participant at risk and needs to be calibrated properly so not to give one trading participant unfair advantage. These timers use a proprietary algorithm factoring for a variety of inputs. These inputs include, but not limited to, market conventions for the specific instrument(s), the complexity of the instrument(s), volatility in the underlying markets, time of day factors which may influence liquidity, number of simultaneous eMOD Sessions on the ECN, and number of participants on the ECN. The table identifies the various timers, describes the purpose of the timers, the events that cause the timer to start and the events that cause the timers to end. The maximum Pre-Configured Default (PCD) time is determined by the algorithm, which will result in the process terminating or moving to the next process so as not to create unnecessary delays or risk to the participants.

FIG. 7 illustrates the technology overview of the MOD-ECN with system processes displayed in three diagrams for greater clarification. Diagram #1 in FIG. 7 illustrates a client with access to the MOD-ECN selecting an OTC instrument for starting a MOD process. The user signs on to the MOD system at a client and is authenticated by the MOD system, and the client software displays via a user interface of the client instruments that may have been or are being traded. The user's client software then waits for the user to input a request to start a temporary, dynamic market for an instrument (a “MOD” for the instrument), at which point the client software makes a determination of whether the user is eligible to initiate a MOD and perform trades that will be cleared by a CCP. If so, the MOD system (e.g., the client software, or another element of the system) determines if the instrument (which may be a standard (“vanilla”) instrument or a complex (combination) instrument, or other suitable instrument) meets the MOD-ECN eligibility requirements for starting a session, as discussed above. Such eligibility requirements may include requirements relating to the CCP. If so, then the MOD system starts a MOD process, including according to example processes above.

Diagram #2 in FIG. 7 illustrates a system process for integration of configurable default Countdown Timer(s) (CDT(s)) and initializing a MOD Private Phase using a Countdown Timer (CDT) to determine a transition to a second phase. Once the system determines the eligibility of the LR and the chosen instrument, the system calculates a Countdown Timer (CDT) length based on one or more factors (examples of which are discussed above) and starts the solicitation process. The MOD system follows MOD process steps (e.g., discussed above) and counts down the timer while waiting for a market improvement of BBO or a trade by the LR. If no trade results before the timer expires (i.e., the CDT has counted down to zero), the first phase is terminated for the LR and the second phase begins. If the LR did not trade during the first phase, in some embodiments the system may provide a consequence for the LR and the event (non-trading) will be logged by the MOD system for later consequence (e.g., not being permitted to trade or initiate a dynamic market for a time, or the non-trading event being identified to potential LPs during a subsequent solicitation phase for the LPs to determine whether they want to bother responding to a dynamic market formed by an LR who may not trade). This diagram #2 of FIG. 7 also shows an overview of steps outlined in FIGS. 1-5 discussed above, of progressing from the private phase to the second (CLOB) phase for follow-on trading.

Diagram #3 in FIG. 7 shows some of the factors maintained in the databases for determining the appropriate configuration of each respective CDT governing the mini-processes outlined above for each instrument in each session, by the CDT Provider.

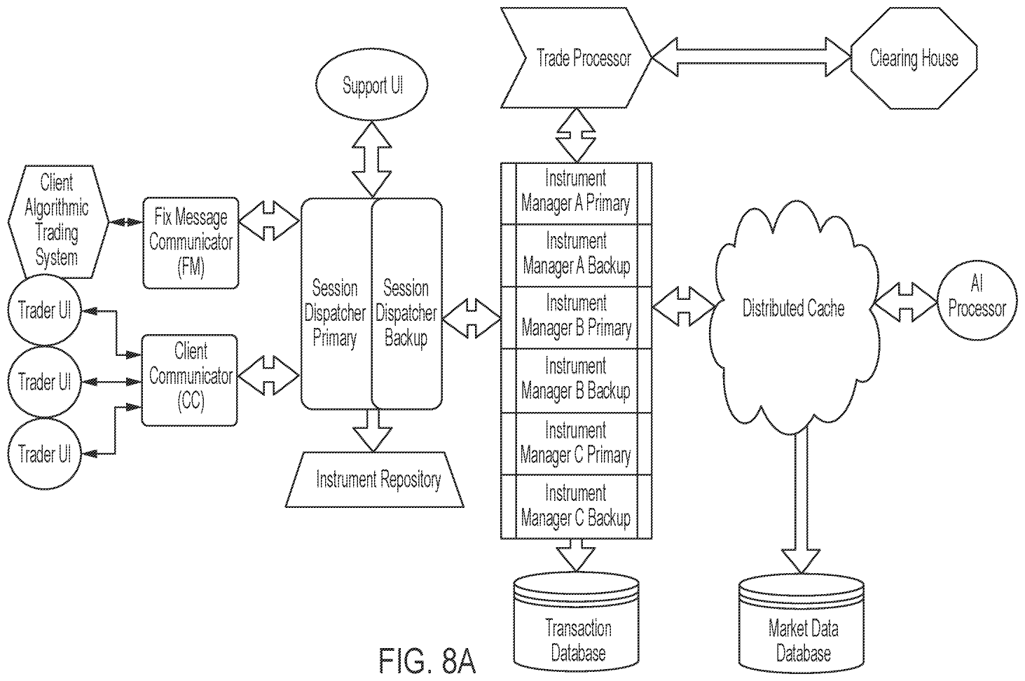

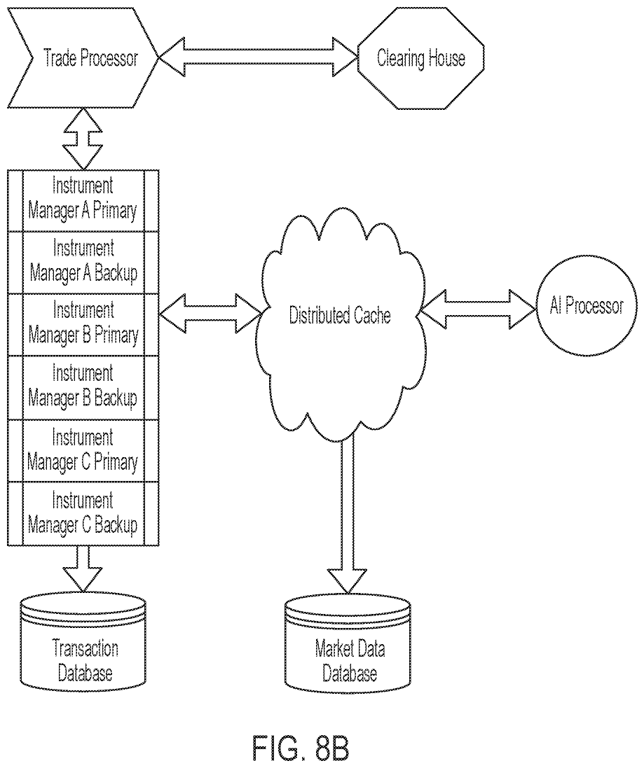

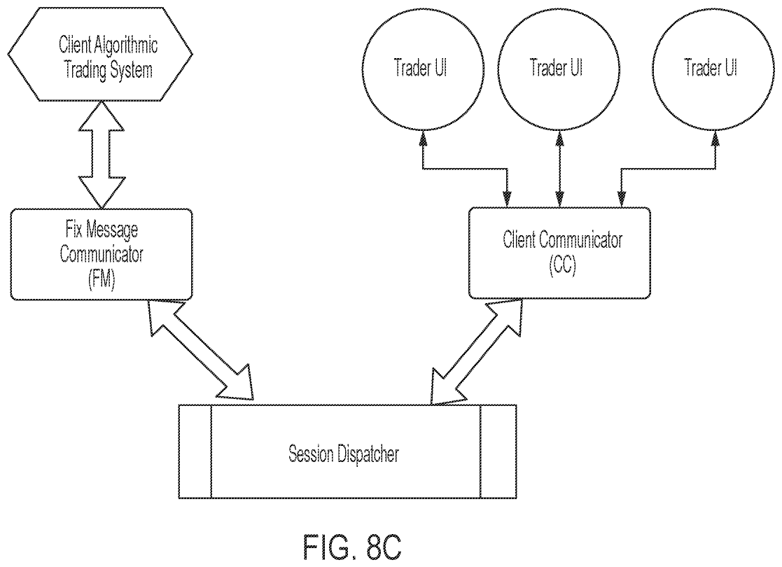

Described below in connection with FIGS. 8A-8C are exemplary devices, communications, and operations of a MOD-ECN with which some embodiments may operate. It should be appreciated that embodiments are not limited to operating in accordance with these examples, or with any of the devices, communications, or operations described below. Other MOD platforms may be implemented in accordance with techniques described herein, including that leverage some or all of the devices, communications, operations, or parameters described below.

FIG. 8A illustrates an overall architecture of one embodiment of a MOD system. The embodiment illustrated in FIG. 8A includes client-facing aspects on the left-hand side of the figure, including a client communicator (CC) facility that communicates with users, illustrated in FIG. 8A as at least three clients each having trader user interfaces (UIs) with which to interact with human users. The human users may be dealer traders and/or customer traders, or users working on behalf of dealers and/or customers. The figure also shows a FIX message communicator (FM) facility to receive electronic messages from a client algorithmic trading system, which may be an automated system that identifies trades to make based on market conditions and sends messages to execute those trades, where the messages may be in a Financial Information Exchange (FIX) protocol or other suitable protocol. Further details of these elements of FIG. 8A are discussed below in connection with FIG. 8C, which also depicts these elements.

FIG. 8A also illustrates, in the middle of the figure, a session dispatch (primary) facility, as well as a session dispatch (backup) facility, both of which may execute functionality described herein to initiate formation of a dynamic market, including by launching an instrument manager for the dynamic market that will handle operations of the dynamic market. These facilities may interact with a support UI to enable an administrator or other user to control operations of or configure the facilities, and may interact with a database of information regarding instruments, termed an “instrument repository” in FIG. 8A, which may store information described above regarding instruments.

FIG. 8A further illustrates, on the right-hand side of the figure, elements for conducting transactions, including instrument managers, trade processors, and more. These elements are further illustrated in FIG. 8B and are discussed below.

The elements of FIG. 8B include instrument mangers to form and operate two-phase MOD sessions in response to a request received from the client communicator facility or FIX message communicator facility, to send and receive messages to/from the client algorithmic trading system and/or trader UIs regarding a dynamic market (examples of which messages are discussed above), and to terminate a market based on conditions discussed above. Each dynamic market may be associated with a primary facility and a backup facility, to provide redundancy in case of error. For a dynamic market, the instrument manager(s) work with LP quotes, build a central limit order book (CLOB), send updates about changes to the top of book to the LR and/or to LP(s), and interacts with the session dispatcher regarding the process. The instrument managers may store data regarding ongoing dynamic markets in a distributed cache, which by nature of being distributed may be protected from failures and may be immediately available to a backup facility in an event of failure of a primary facility. The distributed facility may be instantiated on multiple servers and use synchronization to maintain consistency between the servers and ensure data integrity. The instrument manager(s) may also store information regarding trades or trading history in a transaction database.

Upon a trade being identified for execution in a dynamic market, the instrument manager(s) send the trade to the trade processor for execution. The trade processor may then interact with a clearinghouse process to execute trades with a CCP, which may be implemented according to known techniques.

The AI processor of FIG. 8B may leverage information stored in the market data database to make determinations regarding market conditions and conditions regarding trade of the instrument. The AI processor may, for example, implement operations of the MIM discussed above. For example, the market data database may store a time series of historical quotes regarding instruments and the AI processor may use that information to, for example, calculate what may be a fair market value of an instrument or a recommended or permitted quote spread for the instrument, which can be distributed to market participants. The AI processor may also provide protection to participants in an event of market volatility or sudden changes in market volatility, such as by adjusting timers or ending trade when a market is no longer viable due to changes in market conditions.

FIG. 8C illustrates examples of MOD system elements that were also depicted in the left-hand side of FIG. 8A. The client communicator (CC) facility and FIX message communicator (FM) facility may perform authentication and authorization of traders or automated processes, as they seek to log into the system and become eligible to participate in dynamic markets. These elements also interact with the traders and automated processes regarding instruments and send/receive information regarding instruments, such as by conducting pre-solicitation phase interactions with LRs and/or by conducting solicitation phase interactions with potential LPs, at direction of session dispatchers and/or instrument managers (discussed above in connection with FIGS. 8A-8B). These elements will also, during a dynamic market, output to the traders or automated processes information regarding a CLOB, participant positions in the CLOB, status of timer(s), information regarding current phase, and completed trades in the dynamic market, and will interact with traders and automated processes during a trade or upsize trade process and pass input from the traders and automated processes to the session dispatcher and/or instrument managers.

Techniques operating according to the principles described herein may be implemented in any suitable manner. Included in the discussion above are a series of flow charts showing the steps and acts of various processes that operate a computer-implemented platform for formation, operation, and termination of a dynamic market for temporary trade of a financial instrument. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Tasks that may be implemented in software executed by one or more computing devices (e.g., servers) have been described above. Such tasks may be implemented in one or more functional facilities in some embodiments. It should be appreciated, though, that any functional facilities and division of tasks described above is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some functional facilities may be implemented together with or separately from others (i.e., as a single unit or separate units), or some functional facilities that are included in some embodiments may not be implemented in other embodiments.

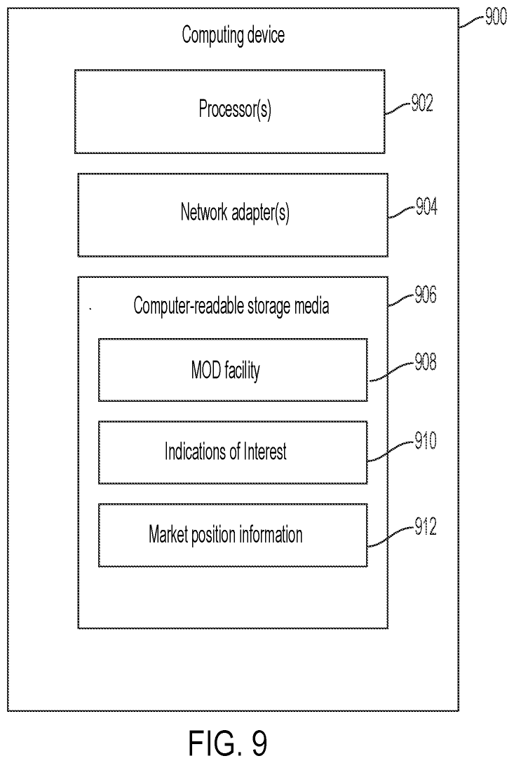

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 906 of FIG. 9 described below (i.e., as a portion of a computing device 900) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 9 illustrates one exemplary implementation of a computing device in the form of a computing device 900 that may be used in a system implementing techniques described herein, although others are possible. It should be appreciated that FIG. 9 is intended neither to be a depiction of necessary components for a computing device to operate as a server of an electronic communication network (ECN) hosting a Market on Demand (MOD) process in accordance with the principles described herein, nor a comprehensive depiction.

Computing device 900 may comprise at least one processor 902, a network adapter 904, and computer-readable storage media 906. Computing device 900 may be, for example, one or more servers (rack-mounted or otherwise), a desktop or laptop personal computer, or any other suitable computing device. Network adapter 904 may be any suitable hardware and/or software to enable the computing device 900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 906 may be adapted to store data to be processed and/or instructions to be executed by processor 902. Processor 902 enables processing of data and execution of instructions. The data and instructions may be stored on the computer-readable storage media 906.

The data and instructions stored on computer-readable storage media 906 may comprise computer-executable instructions implementing techniques which operate according to the principles described herein. In the example of FIG. 9, computer-readable storage media 906 stores computer-executable instructions implementing various facilities and storing various information as described above. Computer-readable storage media 906 may store a MOD facility 908 that performs tasks and operations described above in connection with registering users, initiating a dynamic market, soliciting users, transitioning between phases, executing trades, and/or terminating a market. The MOD facility 908 may leverage a data store 910 of indications of interest and a data store 912 of market level information that LPs exchange in a dynamic market. The MOD facility 908 may operate multiple dynamic markets in parallel for different financial instruments and may have market level information for different markets in the data store 912 (or in different data stores 912).

While not illustrated in FIG. 9, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method of forming a dynamic, anonymous market for over-the-counter (OTC) trade of a financial instrument, the method comprising:
operating at least one server of an electronic communication network (ECN) to carry out a series of acts, the series of acts comprising:
receiving at least one first communication, from a first user of a plurality of users, comprising a description of the financial instrument the first user is seeking to trade;
forming a market for trade of the financial instrument, wherein forming the market comprises:
identifying a plurality of second users, from among the plurality of users, to solicit for trading interest in the financial instrument, wherein identifying the plurality of second users comprises evaluating at least one data store of indications of interest provided by users of the plurality of users to determine whether the financial instrument is one for which an indication of interest indicates a user wants to be solicited, the indications of interest for a user indicating financial instruments and/or types of financial instruments in which the user has indicated interest in being solicited;
outputting to the plurality of second users via the ECN electronic communications soliciting the plurality of second users to provide market level information for a potential trade of the financial instrument, the market level information comprising a bid price and an offer price for the financial instrument, and wherein the electronic communications soliciting the plurality of second users comprise information identifying the financial instrument to the plurality of second users and not identifying the first user to the plurality of second users;
generating order book information from the market level information received from participating users of the plurality of second users solicited in the soliciting, the order information comprising both bid and offer prices for trade in the financial instrument;
prompting the first user to make a trade in the financial instrument with one or more of the participating users at a price indicated by the order book information generated from the market level information received from the participating users; and
following selection of the trade by the first user and/or expiration of a first timer controlling a phase transition of the market,
electronically distributing the order book information for the financial instrument to a plurality of third users, of the plurality of users, and
prompting the plurality of third users for further trades in the financial instrument; and
following expiration of a second timer, terminating the market for trade of the financial instrument, wherein terminating the market comprises configuring the at least one server not to communicate messages relating to trade in the market following termination.

2. The method of claim 1, wherein forming, with the at least one server of the ECN, the market for trade of the financial instrument further comprises setting a length of the first timer controlling the phase transition of the market and/or the second timer relating to termination of the market, wherein setting the length of the first and/or second timers comprises setting the length of the first and/or second timers based at least in part on one or more characteristics of the financial instrument.

3. The method of claim 1, wherein generating the order book information from the market level information received from participating users of the plurality of second users solicited in the soliciting comprises generating the order book information in response to determining that at least a threshold number of quotes have been received from the participating users.

4. The method of claim 1, wherein forming, with the at least one server of the ECN, the market for trade of the financial instrument further comprises executing trades between users of the plurality of third users following the prompting the plurality of third users for further trades, the trades between the users of the plurality of third users not including trades involving the first user.

5. The method of claim 4, wherein executing trades between users of the plurality of third users with the at least one server of the ECN comprises:
determining, from the order book information, at least one matched pair of quotes indicated in the order book, each matched pair of the at least one matched pair corresponding to a pair of users of the plurality of third users; and
executing a trade for each matched pair of quotes of the at least one matched pair of quotes without, following the determining of the matched pair, prompting a corresponding pair of users for the matched pair for whether the corresponding pair of users desires the trade.

6. The method of claim 1, wherein outputting to the plurality of second users via the ECN the electronic communications soliciting the plurality of second users to provide market level information for a potential trade of the financial instrument comprises outputting the electronic communications soliciting the plurality of second users to provide market level information for a potential trade of at least a set amount of the financial instrument.

7. The method of claim 6, wherein forming, with the at least one server of the ECN, the market for trade of the financial instrument further comprises, in response to determining that pair of trading users is to perform a trade of the financial instrument, the pair of trading users including the first user or two users of the plurality of third users:
determining a first desired trading amount for a first trading user of the pair of trading users;
determining a second desired trading amount for a second trading user of the pair of trading users;
determining a lesser amount of the first desired trading amount and the second desired trading amount; and
informing the pair of trading users that the trade will be executed for the lesser amount without informing the first trading user of the second desired trading amount and without informing the second trading user of the first desired trading amount.

8. The method of claim 1, wherein:
operating the at least one server of the ECN to carry out the series of acts further comprises receiving registration information for each user of the plurality of users, the registration information comprising for each user the indications of interest indicating the financial instruments and/or types of financial instruments in which the user is interested in being solicited to trade, wherein receiving the indications of interest comprises receiving one or more indication attributes and/or desired indication values of indication attributes for the financial instruments and/or the types of financial instruments in which the user is interested in being solicited to trade;
receiving from the first user the at least one first communication comprising the description of the financial instrument the first user is seeking to trade comprises receiving one or more instrument attributes and/or one or more instrument attribute values for the financial instrument; and
evaluating the indications of interest provided by users of the plurality of users to determine whether the financial instrument is one for which an indication of interest indicates a user wants to be solicited comprises comparing, for each user of the plurality of users, the one or more instrument attributes and/or one or more instrument attribute values to the one or more indication attributes and/or desired indication values of indication attributes.

9. The method of claim 1, wherein:
receiving from the first user the at least one first communication comprising the description of the financial instrument the first user is seeking to trade comprises receiving an indication of whether the first user would like to buy or sell the financial instrument; and
the electronic communications soliciting the plurality of second users to provide both the bid price and the offer price for the financial instrument do not indicate that the first user has indicated a desire to buy or to sell.

10. At least one computer-readable storage medium having encoded thereon executable instructions that, when executed by at least one processor, cause the at least one processor to carry out a method of forming a dynamic, anonymous market for over-the-counter (OTC) trade of a financial instrument, the method comprising:
operating at least one server of an electronic communication network (ECN) to carry out a series of acts, the series of acts comprising:
receiving at least one first communication, from a first user of a plurality of users, comprising a description of the financial instrument the first user is seeking to trade;
forming a market for trade of the financial instrument, wherein forming the market comprises:
identifying a plurality of second users, from among the plurality of users, to solicit for trading interest in the financial instrument, wherein identifying the plurality of second users comprises evaluating indications of interest provided by users of the plurality of users to determine whether the financial instrument is one for which an indication of interest indicates a user wants to be solicited, the indications of interest for a user indicating financial instruments and/or types of financial instruments in which the user has indicated interest in being solicited;
outputting to the plurality of second users via the ECN electronic communications soliciting the plurality of second users to provide market level information for a potential trade of the financial instrument, the market level information comprising a bid price and an offer price for the financial instrument, and wherein the electronic communications soliciting the plurality of second users comprise information identifying the financial instrument to the plurality of second users and not identifying the first user to the plurality of second users;
generating order book information from the market level information received from participating users of the plurality of second users solicited in the soliciting, the order information comprising both bid and offer prices for trade in the financial instrument;
prompting the first user to make a trade in the financial instrument with one or more of the participating users at a price indicated by the order book information generated from the market level information received from the participating users; and
following selection of the trade by the first user and/or expiration of a timer controlling a phase transition of the market,
electronically distributing the order book information for the financial instrument to a plurality of third users, of the plurality of users, and
prompting the plurality of third users for further trades in the financial instrument; and
terminating the market for trade of the financial instrument, wherein terminating the market comprises configuring the at least one server not to communicate messages relating to trade in the market following termination.

11. The at least one computer-readable storage medium of claim 10, wherein forming, with the at least one server of the ECN, the market for trade of the financial instrument further comprises setting a length of the timer controlling the phase transition of the market, wherein setting the length of the timer comprises setting the length of the timer based at least in part on one or more characteristics of the financial instrument.

12. The at least one computer-readable storage medium of claim 10, wherein forming, with the at least one server of the ECN, the market for trade of the financial instrument further comprises executing trades between users of the plurality of third users following the prompting the plurality of third users for further trades, the trades between the users of the plurality of third users not including trades involving the first user.

13. The at least one computer-readable storage medium of claim 12, wherein executing trades between users of the plurality of third users with the at least one server of the ECN comprises:
determining, from the order book information, at least one matched pair of quotes indicated in the order book, each matched pair of the at least one matched pair corresponding to a pair of users of the plurality of third users; and
executing a trade for each matched pair of quotes of the at least one matched pair of quotes without, following the determining of the matched pair, prompting a corresponding pair of users for the matched pair for whether the corresponding pair of users desires the trade.

14. The at least one computer-readable storage medium of claim 10, wherein:
outputting to the plurality of second users via the ECN the electronic communications soliciting the plurality of second users to provide market level information for a potential trade of the financial instrument comprises outputting the electronic communications soliciting the plurality of second users to provide market level information for a potential trade of at least a set amount of the financial instrument;
forming, with the at least one server of the ECN, the market for trade of the financial instrument further comprises, in response to determining that pair of trading users is to perform a trade of the financial instrument, the pair of trading users including the first user or two users of the plurality of third users:
determining a first desired trading amount for a first trading user of the pair of trading users;
determining a second desired trading amount for a second trading user of the pair of trading users;
determining a lesser amount of the first desired trading amount and the second desired trading amount; and
informing the pair of trading users that the trade will be executed for the lesser amount without informing the first trading user of the second desired trading amount and without informing the second trading user of the first desired trading amount.

15. The at least one computer-readable storage medium of claim 10, wherein:
operating the at least one server of the ECN to carry out the series of acts further comprises receiving registration information for each user of the plurality of users, the registration information comprising for each user the indications of interest indicating the financial instruments and/or types of financial instruments in which the user is interested in being solicited to trade, wherein receiving the indications of interest comprises receiving one or more indication attributes and/or desired indication values of indication attributes for the financial instruments and/or the types of financial instruments in which the user is interested in being solicited to trade;
receiving from the first user the at least one first communication comprising the description of the financial instrument the first user is seeking to trade comprises receiving one or more instrument attributes and/or one or more instrument attribute values for the financial instrument; and
evaluating the indications of interest provided by users of the plurality of users to determine whether the financial instrument is one for which an indication of interest indicates a user wants to be solicited comprises comparing, for each user of the plurality of users, the one or more instrument attributes and/or one or more instrument attribute values to the one or more indication attributes and/or desired indication values of indication attributes.

16. At least one server of an electronic communication network (ECN), the at least one server comprising:
at least one processor; and
at least one computer-readable storage medium having encoded thereon executable instructions that, when executed by the at least one processor, cause the at least one processor to carry out a method of forming a dynamic, anonymous market for over-the-counter (OTC) trade of a financial instrument, the method comprising:
receiving at least one first communication, from a first user of a plurality of users, comprising a description of the financial instrument the first user is seeking to trade;
forming a market for trade of the financial instrument, wherein forming the market comprises:
identifying a plurality of second users, from among the plurality of users, to solicit for trading interest in the financial instrument, wherein identifying the plurality of second users comprises evaluating indications of interest provided by users of the plurality of users to determine whether the financial instrument is one for which an indication of interest indicates a user wants to be solicited, the indications of interest for a user indicating financial instruments and/or types of financial instruments in which the user has indicated interest in being solicited;
outputting to the plurality of second users via the ECN electronic communications soliciting the plurality of second users to provide market level information for a potential trade of the financial instrument, the market level information comprising a bid price and an offer price for the financial instrument, and wherein the electronic communications soliciting the plurality of second users comprise information identifying the financial instrument to the plurality of second users and not identifying the first user to the plurality of second users;
generating order book information from the market level information received from participating users of the plurality of second users solicited in the soliciting, the order information comprising both bid and offer prices for trade in the financial instrument;
prompting the first user to make a trade in the financial instrument with one or more of the participating users at a price indicated by the order book information generated from the market level information received from the participating users; and
following selection of the trade by the first user and/or expiration of a timer controlling a phase transition of the market,
electronically distributing the order book information for the financial instrument to a plurality of third users, of the plurality of users, and
prompting the plurality of third users for further trades in the financial instrument; and
terminating the market for trade of the financial instrument, wherein terminating the market comprises configuring the at least one server not to communicate messages relating to trade in the market following termination.

17. The at least one server of claim 16, wherein forming the market for trade of the financial instrument further comprises setting a length of the timer controlling the phase transition of the market, wherein setting the length of the timer comprises setting the length of the timer based at least in part on one or more characteristics of the financial instrument.

18. The at least one server of claim 16, wherein forming, with the at least one server of the ECN, the market for trade of the financial instrument further comprises executing trades between users of the plurality of third users following the prompting the plurality of third users for further trades, the trades between the users of the plurality of third users not including trades involving the first user.

19. The at least one server of claim 18, wherein executing trades between users of the plurality of third users with the at least one server of the ECN comprises:
determining, from the order book information, at least one matched pair of quotes indicated in the order book, each matched pair of the at least one matched pair corresponding to a pair of users of the plurality of third users; and
executing a trade for each matched pair of quotes of the at least one matched pair of quotes without, following the determining of the matched pair, prompting a corresponding pair of users for the matched pair for whether the corresponding pair of users desires the trade.

20. The at least one server of claim 16, wherein:
outputting to the plurality of second users via the ECN the electronic communications soliciting the plurality of second users to provide market level information for a potential trade of the financial instrument comprises outputting the electronic communications soliciting the plurality of second users to provide market level information for a potential trade of at least a set amount of the financial instrument;
forming, with the at least one server of the ECN, the market for trade of the financial instrument further comprises, in response to determining that pair of trading users is to perform a trade of the financial instrument, the pair of trading users including the first user or two users of the plurality of third users:
determining a first desired trading amount for a first trading user of the pair of trading users;
determining a second desired trading amount for a second trading user of the pair of trading users;
determining a lesser amount of the first desired trading amount and the second desired trading amount; and
informing the pair of trading users that the trade will be executed for the lesser amount without informing the first trading user of the second desired trading amount and without informing the second trading user of the first desired trading amount.
